(19) United States
(12) Patent Application Publication
(10) Pub. No.: US 2019/0209404 A1
(43) Pub. Date: Jul. 11, 2019

(54) A stair-climbing device for a wheelchair, a wheelchair suitable for installing such a stair-climbing device and a wheelchair equipped with such a stair-climbing device

(71) Applicant: WHEELSTAIR SP. Z O.O., Lublin (PL)

(72) Inventor: Jacek KÜHNL-KINEL, Konstancin-Jeziorna (PL)

(21) Appl. No.: 16/325,554

(22) PCT Filed: Mar. 7, 2018
(86) PCT No.: PCT/IB2018/051477

§ 371 Date: Feb. 14, 2019

(30) Foreign Application Priority Data
Mar. 9, 2017 (PL) P.420785

(51) Int. Cl. A61G 5/06; A61G 5/12; A61G 5/04; A61G 5/10

(52) U.S. Cl. CPC A61G 5/066; A61G 5/1005; A61G 5/04; A61G 5/122

(57) ABSTRACT

The object of the invention is a stair-climbing device (1) for moving a wheelchair (2) on stairs by means of muscular force of a person sitting on the wheelchair (2) or by means of an electric drive assembly (76) without the assistance of third party. The stair-climbing device (1) comprises two crawler units (89), which are connected with each other by a drive axle (44); connecting units comprising an attachment devices (17) mountable on each hub of the main wheel (4) of the wheelchair (2) and a holders (26) for rotational mounting on the main wheel (4) to each attachment device (17) and comprising main arms (31) mounted slidingly in the holders (26) and rotationally connected at one its end with the main axle (44) for manual changing a position of the stair-climbing device (1) in relation to the wheelchair (2) between a transport mode position, stair-climbing mode position and optionally landing mode, if the landing mode is present; a levelling units (105) for setting the attached wheelchair (2) in a horizontal position during stair climbing. The invention also includes a wheelchair (2) suitable for attaching a stair-climbing device (1), wherein the wheelchair (2) comprises a frame (6), main wheels (4), front wheels (5), a seat (3) and a back-rest (8). Moreover, the invention includes a wheelchair (2) with a mounted stair-climbing device (1).

### TECHNICAL FIELD

The object of the invention is a stair-climbing device for a wheelchair. The object of the invention is also a wheelchair suitable for installing the stair-climbing device according to the invention. Further object of the invention is a wheelchair equipped with such a stair-climbing device. The invention relates to a stair-climbing device that can be attached to wheelchairs, which enables stair-climbing both in a manual mode by means of muscular force of the wheelchair occupant and in an electric mode by means of an electric drive.

### PRIOR ART

The problem of movement of disabled persons up and down stairs has been the object of numerous studies, tests and inventions, which have taken place over the course of decades and which have been often implemented in production. The prior art with regard to equipment which enables disabled people to move up and down stairs covers a range of solutions that include dependent non-autonomous devices which require the assistance of a third party and independent autonomous devices which make it possible for a disabled person to climb up and down the stairs without the assistance of a third party.

The most widely used autonomous devices are specialised wheelchairs equipped with units which enable wheelchair movement up and down stairs by the use of manual force and/or an electric drive suitable for various types of drive systems.

The manually-driven devices, although much cheaper in production, are not widely used because they cannot be easily detached from the wheelchair when they are not needed; laborious alterations of standard wheelchairs are also necessary which often make the use of such wheelchairs for their original purposes impossible. In most cases manual drive is transmitted to the crawler unit of these devices through the rear wheels of the wheelchair with a small lever. Consequently, such devices require high strength and physical fitness from the user. It is also important to note that such devices have a relatively low level of safety, resulting from the absence of automatic safety devices that would operate independently to the will of their users. Weight and dimensions of such stair-climbing devices make their transport in the course of normal horizontal movement of a wheelchair very burdensome for the user, in the best case.

American patent application No. US2006076739 discloses a wheelchair coupled with a stair-climbing device operable by a wheelchair user themselves. The device includes crawler units which are shifted manually by an unassisted wheelchair user from a transport position, wherein the crawler units are raised above the ground while the wheelchair stands on its wheels, into a stair-climbing position, wherein the crawler units are lowered below the wheelchair wheels. The position is changed by means of an electrically-operated lift mechanism. The device comprises a levelling unit which enables horizontal positioning of the wheelchair while it is moving on stairs. The device does not allow the user to move on stairs by using their muscular force, nor to transport it on the wheelchair when moving on level surface.

U.S. Pat. No. 3,111,331 discloses a wheelchair which can be operated by its occupant where such a wheelchair is also suitable for stair-climbing and for movement on level surface. The wheelchair is equipped with crawler units that are connected to levers by means of which the user can shift these crawler units from an operating position to an idle position, depending on the surface on which they travel; the crawler units are also connected to a drive system, comprising drive wheels. The crawler unit comprises crawler belts with their drive wheels, connected to the drive system, which can be disconnected from it. Moreover, the wheelchair comprises a device to control the crawler belt to move in one direction. When the crawler belts are in the idle position, the wheelchair can be moved manually with the use of main wheels. The presented solution requires the permanent connection of the crawler units which are specially designed for this purpose, to the wheelchair.

In German utility model No. DE8614092 a wheelchair is described which is suitable for movement both on level surface and on stairs by means of the manual force of the user. The wheelchair comprises crawler units with crawler belts, driven by the rotation of main wheels that are connected indirectly with a wheelchair frame through a drive system. The crawler units are moved by the user from the operating position to the idle position by means of a worm screw. It is required however for the solution according to the German utility model to have a wheelchair of a special design and it does not enable easy disconnection of the crawler units from the wheelchair nor does it provide the possibility of using an electric drive.

In Chinese patent No. CN104546328 an electric wheelchair is disclosed that is suitable for optional stair-climbing with the use of repositionable crawler-type traction belts. The crawlers move backwards and forwards as a result of a swivel motion. No use of the wheelchair for manually-driven movement is indicated there. The device is not suitable for climbing flights of stairs and does not enable the user to easily disconnect it from the wheelchair, which is specially adapted to it.

From U.S. Pat. No. 3,529,688 a wheelchair is known which is equipped with a device enabling its movement on level surface and on stairs, while its mode of operation can be changed by the user themselves. The device comprises parallel double-element traction belt units, fastened to their connecting axles, which can be shifted by the user by means of a lever-and-rod system and actuators operated manually by the user. The wheelchair is equipped with an electric drive and its movement on stairs by means of manual drive is not possible. The device cannot be disconnected from the wheelchair easily and quickly.

Australian patent No. AU197472081 describes a wheelchair that is equipped with a device enabling stair-climbing, comprising traction belts, such as chains, which are shifted from the idle position to the operating position when necessary. In order to start stair climbing it is necessary to shift the axle of the rear wheels of the wheelchair upwards by means of a lever. The drive system is relatively complicated and rather does not enable the quick adaptation of the existing wheelchairs for stair-climbing. The drive system cannot be easily disconnected from the wheelchair.

### SUMMARY OF THE INVENTION

The object of the present invention is to provide a stair-climbing device for a wheelchair which can be driven by a wheelchair user manually and/or by an electric drive, enabling simple shifting between its modes of operation and which can be used without help of a third party.

The object of the present invention is to provide a stair-climbing device for a wheelchair which can be easily attached to the existing wheelchairs.

The object of the present invention is to provide a stair-climbing device for a wheelchair which features high transverse stability during stair-climbing and ensures user's safety regardless of their will.

The object of the present invention is to provide a stair-climbing device for a wheelchair with a relatively low weight and dimensions and which can be transported on the wheelchair without the assistance of a third party when it is not used for stair-climbing.

The object of the present invention is to provide a stair-climbing device for a wheelchair which can be easily and quickly detached from or attached to a wheelchair without the assistance of a third party.

The object of this invention is also a wheelchair integrated with a stair-climbing device wherein such a wheelchair is easily and at little cost adaptable to the stair-climbing device attached to it to enable this wheelchair to go up and down stairs. Moreover, the object of the present invention is an assembly of a wheelchair and a stair-climbing device which can easily and quickly be put together to enable to go up and down stairs in the wheelchair equipped with the stair-climbing device.

The above listed and other objects of this invention which will result from the following description are achieved by means of a stair-climbing device for a wheelchair with main features, as indicated in independent claim 1.

Specific examples of the embodiment of the invention are covered by dependent claims 2-31.

A wheelchair adapted for mounting a stair-climbing device on it, comprises the features, as specified in claim 32.

A wheelchair comprising a stair-climbing device for moving this wheelchair up or down stairs, comprises the features, as specified in claim 33.

The stair-climbing device according to the invention allows a person moving in wheelchair to climb up or down the stairs without the assistance of third parties. It is suitable for being mounted on any type of wheelchair, without any significant structural changes in the wheelchair being necessary.

The stair-climbing device according to the invention may be easily and quickly coupled with a wheelchair by a wheelchair occupant themselves. When a stair-climbing device, according to the invention, for a wheelchair is not needed, it may be easily and quickly detached from or attached to the wheelchair by the wheelchair occupant themselves. The stair-climbing device according to the invention may be put into stair-climbing mode by the wheelchair occupant themselves. Once the stair-climbing operation is completed the stair-climbing device according to the invention may be put to the transport position by the wheelchair occupant.

Moreover, the stair-climbing device according to the invention can be transported on the wheelchair during its normal movement on horizontal surface without affecting the comfort of the user.

An additional advantage is the ability of the wheelchair equipped with the stair climbing device according to the invention to climb stairs by means of manual drive and/or an electric drive, with the possibility of changing type of the drive at any time. Use of the manual drive does not require from the user to apply a force greater than the force required in the case of the manual drives which use the main wheels of a wheelchair.

This stair-climbing device according to the invention has a high transverse stability and ensures safe stopping the wheelchair in uncontrolled situations while moving on stairs, such as, for example, loss of consciousness by the wheelchair occupant, too fast descending on stairs.

Due to the fact that the stair-climbing device according to the invention is operated intuitively and without the need of a significant force, it makes disabled people independent from the assistance of third parties, which significantly contributes to increasing their mobility and, in consequence, to an improvement in the standard of living of the user.

### BRIEF DESCRIPTION OF THE FIGURES

The invention is presented in exemplary and non-limiting embodiments in the following description, with reference to the Figures of the drawing, wherein:

FIG. 1 shows a perspective view from the front and side of the wheelchair according to the invention, without an attached stair-climbing device according to the invention;

FIG. 2 shows a perspective view from the front and top of one preferred embodiment of the stair-climbing device according to the invention, without the wheelchair according to the invention attached to it, in the position ready for storage of this device;

FIG. 3 shows a perspective view from the front and top of another preferred embodiment of the stair-climbing device according to the invention, without the wheelchair according to the invention attached to it, in the position ready for storage of this device;

FIG. 4 shows a perspective view from the front and top of yet another preferred embodiment of the stair-climbing device according to the invention, without the wheelchair according to the invention attached to it, in the position ready for storage of this device;

FIG. 5 shows a perspective view from the front and side of the assembly of the wheelchair and the stair-climbing device according to the embodiment of the device, as shown in FIG. 2, connected with each other and ready for operation in a stair-climbing mode;

FIG. 6 shows a rear view of an assembly of a wheelchair and a stair-climbing device, as shown in FIG. 5;

FIG. 7 shows a perspective view from the front and side of the assembly of the wheelchair and the stair-climbing device according to yet another embodiment of the device, connected with each other and ready for operation in a stair-climbing mode;

FIG. 8 shows a perspective view from the front and side of the assembly of the wheelchair and the stair-climbing device according to the embodiment of the device, as shown in FIG. 2, connected with each other and ready for operation in a transport mode;

FIG. 9 shows a rear view of the assembly of wheelchair and stair-climbing device, as shown in FIG. 8;

FIG. 10 shows a perspective view from the front and side of the assembly of the wheelchair with the stair-climbing device according to one of the preferred embodiments of the device, as shown in FIG. 2, connected with each other and prepared for being used in transport mode;

FIG. 11 shows one of the preferred embodiments of the stair-climbing device with the collapsible main axle and collapsible drive axle;

FIG. 12 shows another preferred embodiment of the stair-climbing device with the collapsible main axle and collapsible drive axle;

FIG. 13 shows yet another preferred embodiment of the stair-climbing device with the collapsible main axle and collapsible drive axle;

FIG. 14 shows a perspective view from the side of the connecting unit of the stair-climbing device according to the invention attached to the wheelchair, comprising the attachment device mounted on a wheelchair hub and a main arm holder;

FIG. 15 shows a view of the attachment device of the connecting unit, as shown in FIG. 14, in a cross section perpendicular to the hub of the wheelchair main wheel;

FIG. 16 shows a view of a main arm of the stair-climbing device attached to the wheelchair and a holder of this device, with a longitudinal cross section of the main arm;

FIG. 17 shows a detail of the connection of a manual drive arm with a ratchet device mounted on a drive axle, in a top view of the stair-climbing device and in partial cross section;

FIG. 18 shows a cross section of the connection of the crawler unit frame with the main axle in cross section; where both frames are connected to the main axle in exactly the same way;

FIG. 19 shows a view from the bottom and a cross section of a frame locking mechanism used for locking the frame position on the length of the main axle in the stair-climbing and in a landing mode;

FIG. 20 shows a partial side view of the assembly of the wheelchair and stair-climbing device, as shown in FIG. 5, with the stair-climbing device in a transport mode; in particular it shows a guide of a stabilising strut in one of the crawler unit frames;

FIG. 21 shows a top view of the assembly of the wheelchair and stair-climbing device, as shown in FIG. 5, with the stair-climbing device in a stair-climbing mode; it also shows in section connections of the main axle and the stabilising strut;

FIG. 22 shows an external side view of the crawler unit of the stair-climbing device, with longitudinal cross sections through a front support and a slider of the stabilising strut;

FIG. 23 shows a perspective view from the side and front of the supporting unit;

FIG. 24 shows a cross sectional view of a locking mechanism of the front arm of the supporting unit;

FIG. 25 shows a side view of the levelling unit attached to the wheelchair frame coupled with the supporting unit;

FIG. 26 shows a sectional top view of a mechanism for disconnecting the drive axle from the drive wheel of the crawler unit;

FIG. 27 shows a cross-sectional view of a safety brake mechanism mounted on the drive axle of the stair-climbing device;

FIG. 28 shows a view, with partial cross sections, of a drive unit and its location in relation to the drive axle and the main axle of the stair-climbing device;

FIG. 29 shows a side view of the assembly of the wheelchair and the stair-climbing device, as shown in FIG. 5 wherein the stair-climbing device is in a stair-climbing mode, step 0: preparation for stair climbing;

FIG. 30 shows a side view of the assembly of the wheelchair and the stair-climbing device, as shown in FIG. 5 wherein the stair-climbing device is in the stair-climbing mode, step 1: approaching the stairs;

FIG. 31 shows a side view of the assembly of the wheelchair and the stair-climbing device, as shown in FIG. 5, wherein the stair-climbing device is in the stair-climbing mode, step 2: the frames and the crawler units are being taken off from the hanger;

FIG. 32 shows a perspective view from the side and rear of the assembly of the wheelchair and the stair-climbing device, as shown in FIG. 5 wherein the stair-climbing device is in the stair-climbing mode, step 3: the crawler units are being moved apart;

FIG. 33 shows a side view of the assembly of the wheelchair and the stair-climbing device as shown in FIG. 5, wherein the stair-climbing device is in the stair-climbing mode, step 4: the crawler units are being lowered onto the ground;

FIGS. 34 to 38 show perspective views from the side and top of the assembly of the wheelchair and the stair-climbing device, as shown in FIG. 5, wherein the stair-climbing device is in the stair-climbing mode, next phases of step 5: the stair-climbing device is being set stair climbing;

FIG. 39 shows a side view of the assembly of the wheelchair and the stair-climbing device, as shown in FIG. 5, wherein the stair-climbing device is in the stair-climbing mode, step 6: commencement of climbing onto the stairs;

FIG. 40 shows a side view of the assembly of the wheelchair and the stair-climbing device, as shown in FIG. 5, wherein the stair-climbing device is in the stair-climbing mode, step 7: stair climbing;

FIG. 41 shows a side view of the assembly of the wheelchair and the stair-climbing device, as shown in FIG. 5, wherein the stair-climbing device is in the stair-climbing mode, step 8: transition to horizontal movement;

FIG. 42 shows a side view of the assembly of the wheelchair and the stair-climbing device, as shown in FIG. 5, wherein the stair-climbing device is in a landing mode, step 1: rolling off the main axle;

FIG. 43 shows a side view of the assembly of the wheelchair and the stair-climbing device, as shown in FIG. 5, wherein the stair-climbing device is in the landing mode, step 2: the crawler units are being raised and the wheelchair can travel on horizontal surface;

FIG. 44 shows a perspective view from the side and top of the assembly of the wheelchair and the stair-climbing device, as shown in FIG. 5, wherein the stair-climbing device is in a transport mode, step 1: the supporting unit is being locked;

FIG. 45 shows a perspective view from the side and top of the assembly of the wheelchair and the stair-climbing device, as shown in FIG. 5, wherein the stair-climbing device is in the transport mode, step 2: the crawler units are being lifted to the vertical position;

FIG. 46 shows a perspective view from the side and rear of the assembly of the wheelchair and the stair-climbing device, as shown in FIG. 5, wherein the stair-climbing device is in the transport mode, step 3: the crawler units are being moved closer together;

FIG. 47 shows a perspective view from the side and rear of the assembly of the wheelchair and the stair-climbing device, as shown in FIG. 5, wherein the stair-climbing device is in the transport mode, step 4: the crawler units are being hung on the hanger.

### DESCRIPTION OF THE PREFERRED EMBODIMENTS

In this description of the stair-climbing device the directions “forward”, “backward” and “transverse” refer respectively to the directions in accordance with the front and the rear of the wheelchair when the stair-climbing device is attached to it. The directions “down” and “up” refer respectively to the directions in relation to the ground on which the wheelchair together with the stair-climbing device are moving. The directions “left” and “right” refer respectively to the axle of the stair-climbing device or the wheelchair, when looking from the rear to the front. The terms “internal” or “inner” and “external” or “outer” refer respectively to the location which is closer to or further away from the axle of the stair-climbing device and the wheelchair or another component to which this term refers. The term “central” defines the position relative to the centreline of the wheelchair or of the plane between the wheelchair main wheels. Where it is not clearly stated otherwise, the numbering of individual components refers to the same components located on the left and on the right side of the stair-climbing device or wheelchair.

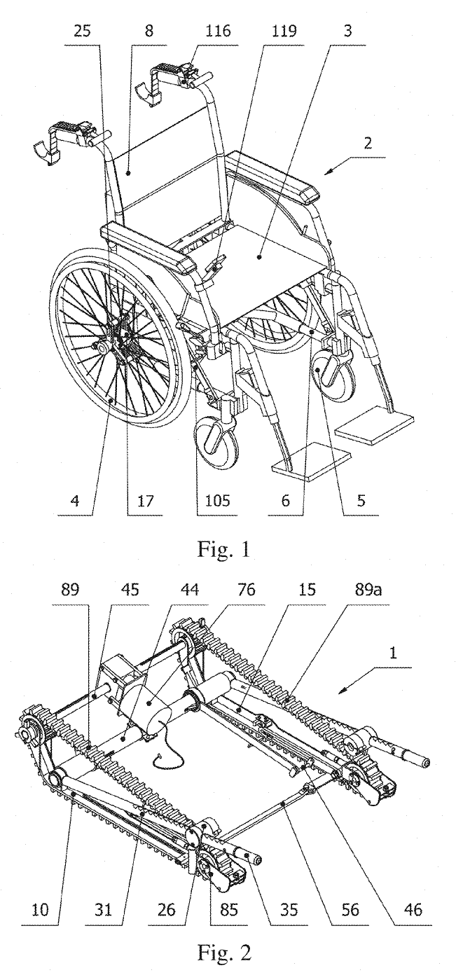

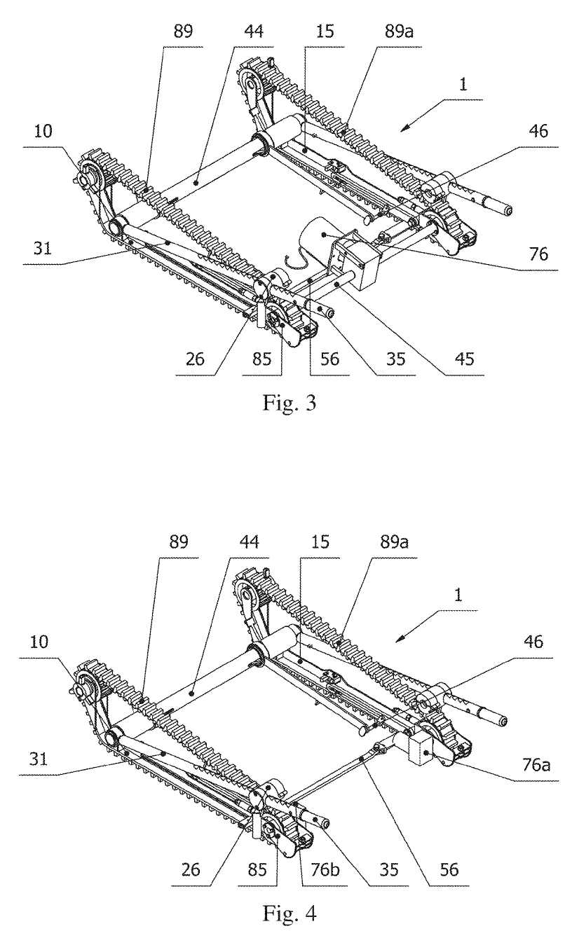

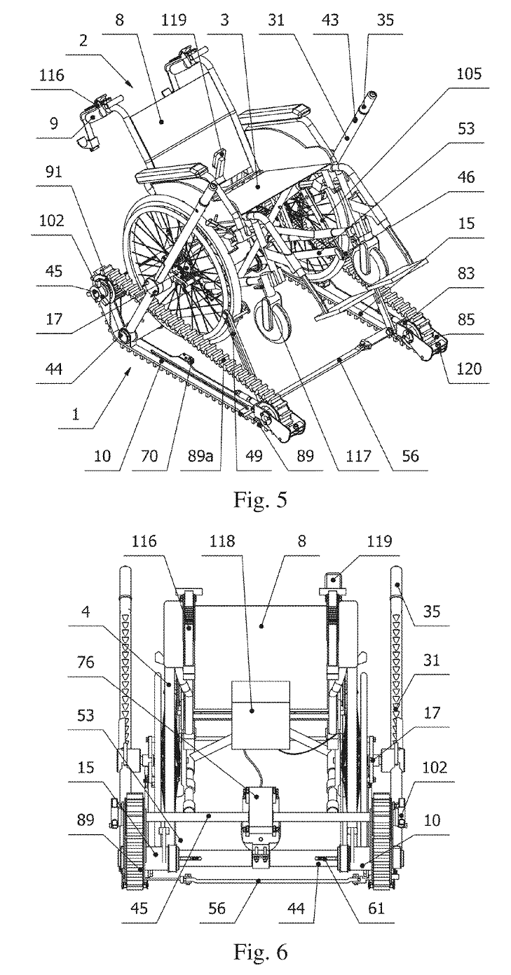

FIG. 1 shows the wheelchair 2 according to the invention, adapted to work with the stair-climbing device 1. One of the preferred embodiments of the stair-climbing device 1 according to the invention which is intended to be mounted to the wheelchair 2, is shown in FIG. 2. FIG. 3 shows another preferred embodiment of the stair-climbing device 1 according to the invention which is intended to be attached to the wheelchair 2. FIG. 4 shows yet another preferred embodiment of the stair-climbing device 1 according to the invention which is intended to be attached to the wheelchair 2. FIGS. 5 to 10 show the assembly of the wheelchair 2 and the stair-climbing device 1 attached to the wheelchair 2 in different modes.

Stair-climbing device 1 interoperates with the wheelchair 2 in the following modes:
Idle position wherein the stair-climbing device 1 is not used and is completely disconnected from the wheelchair and stored until such time as it is required to be used (as shown in FIGS. 2 to 4). The stair-climbing device 1 may be stored at any place and in any orientation. The stair-climbing device 1 according to the invention may be stored, for example, but without limitation, at home, in the garage, shed, attic, cellar, etc. The stair-climbing device 1 according to the invention may be stored, for example, but without limitation, in a horizontal position on the crawlers, as shown in FIGS. 2 to 4, leaning against a wall or hung on a wall.
Stair-climbing mode, wherein the stair-climbing device 1 enables a wheelchair 2 to climb up or down the stairs (as shown in FIGS. 5 to 7);
Optional landing mode, wherein the wheelchair 2 moves on a stairway landing between successive flights of stairs (as shown in FIG. 43);
Transport mode, wherein the stair-climbing device 1 is not operated but remains attached to the wheelchair 2, while the wheelchair 2 is used to travel on horizontal surface (as shown in FIGS. 8 to 10).

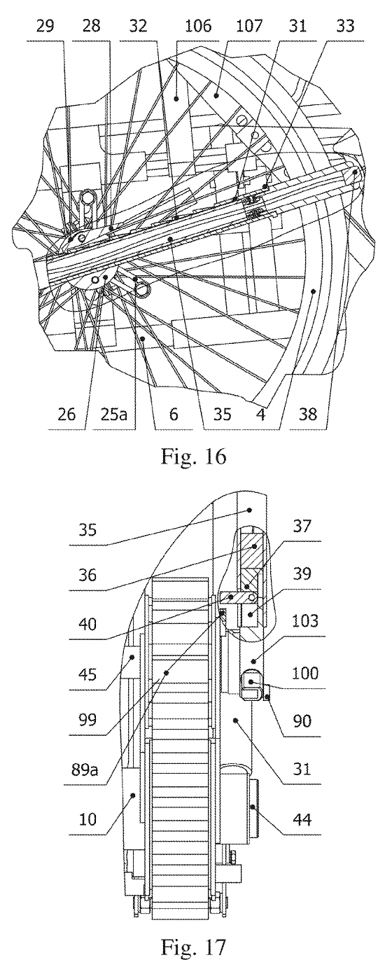

The wheelchair 2, as shown in FIG. 1 and further Figures, comprises a frame 6 with main wheels 4 fixed to it which are the rear wheels for manual driving the wheelchair 2 by its occupant, front wheels 5, a seat 3 and a back-rest 8. The main wheels 4 are intended to manually drive the wheelchair 2 by the user who occupies the seat 3. In order to adapt a typical wheelchair 2 to be able to interoperate with the stair-climbing device 1 according to the invention the wheelchair 2 is equipped with attachment devices 17 mounted on hubs of the main wheels 4 of the wheelchair 2, a fastening element 106 mounted to the frame 6 of the wheelchair 2 for attaching a levelling unit of the wheelchair 2, as shown in FIGS. 1 and 16. The wheelchair 2 also comprises a hanger 116 mounted to it to hung the stair-climbing device 1 in the transport mode.

The stair-climbing device 1 according to the invention comprises two crawler units 89. Each such unit is made up of a frame 10, 15 and a crawler belt 89a. The crawler units 89 are connected with each other by a transverse main axle 44, and the crawler units 89 are mounted non-rotationally on the main axle 44.

In a preferred embodiment of the stair-climbing device 1, the crawler units 89 are mounted slidingly on the main axle 44 in such a way that they can slide along this axle 44 between a slid-apart position in which the crawler units 89 are located apart from each other and a slid-together position, in which the crawler units 89 are located close to each other. In one of the preferred embodiments of the stair-climbing device 1, the crawler units 89 in the slid-together position are located near the corresponding main wheels 4 of the wheelchair 2 and near the ends of the main axle 44. In an even more preferred embodiment, the crawler units 89 in the slid-apart position are located on the inner sides of the corresponding main wheels 4 of the wheelchair 2 and further away from the ends of the main axle 44 (not shown in the Figures). In another more preferred embodiment of the stair-climbing device 1 the crawler units 89 are located on the external sides of the corresponding main wheels 4 of the wheelchair 2 and in close proximity to the ends of the main axle 44, as shown in FIG. 5. The stair-climbing device 1 together with the wheelchair 2 the latter embodiment is particularly stable when moving on stairs. Their stability is increased as the crawler units 89 are spaced as far away from each other as possible where the support of the wheelchair 2 on the crawler units 89 in stair-climbing mode is the widest possible. In a preferred embodiment of the stair-climbing device the crawler units 89 in the slid-together position are situated between the main wheels 4 at the centre of the wheelchair 2 and vertically behind the back-rest 8 of the wheelchair 2, as shown in FIGS. 8 to 10. In another preferred embodiment the crawler units 89 in slid-together position are located vertically behind the back-rest 8 of the wheelchair 2 and near to one of the main wheels 4 of the wheelchair 2.

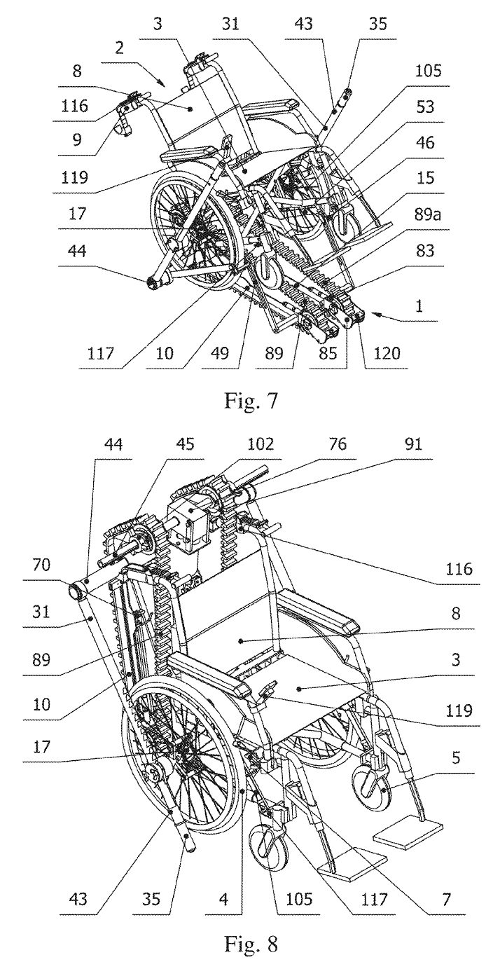

In another preferred embodiment of the stair-climbing device 1 the crawler units 89 are non-slidingly mounted on the main axle 44. This means that the crawler units 89 in such an embodiment of the stair-climbing device 1 are in a fixed position on the main axle 44. In an even more preferred embodiment of the stair-climbing device 1, as shown in FIG. 7, the crawler units 89 are fixed to the main axle 44 in a position between the main wheels 4 of the wheelchair 2 and this position is the same in the transport mode as in the stair-climbing mode.

In the presented exemplary embodiment each crawler unit 89 comprises a frame 10, 15 located parallelly to the other crawler unit 89. The frame 10, 15 has the form of a profile with a rear part that is bent upwards at an obtuse angle. The frames 10 and 15 of the crawler units 89 are connected with each other by the main axle 44 in such a way that they cannot rotate in relation to it. While the frames 10, 15 can slide on this main axle 44 or not, as described above in the various embodiments of the stair-climbing device 1.

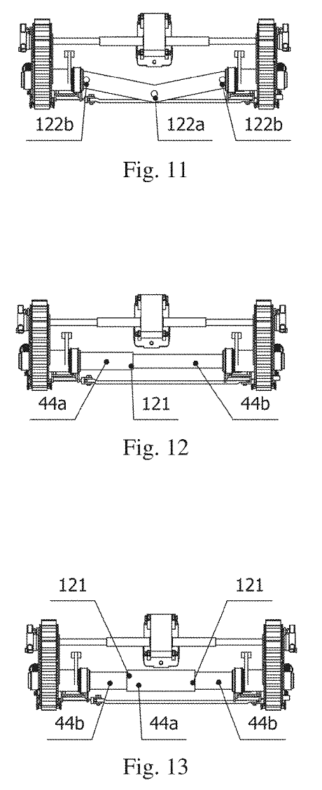

In the front ends of each frame 10, 15 at least one separate axle 84 is fixed, on which a front wheel 83 of the crawler units 89 is mounted so that it is able to rotate. The number of wheels depends on the type and on the size of the frame 10, 15. A drive wheel 91 for driving the crawler units 89 is mounted on the rear ends of each frame 10, 15. Crawler belts 89a are wrapped around the drive wheel 91 and the front wheel 83 of each frame 10, 15; the purpose of the belts is to take over the drive from the drive wheel 91 and transmit it onto the ground in order to move the stair-climbing device 1 with the wheelchair 2 mounted on it. A reverse configuration of the drive assemblies is also possible, wherein the drive wheel 91 is mounted rotationally on the front ends of each frame 10, 15, while the front wheel 83 is mounted rotationally on the rear end of each frame 10, 15 of the crawler units 89. Such a configuration is particularly preferable because, for the stair-climbing device that is equipped with the driving mechanism comprising the drive units 76, 76a, 76b, as described further in this document, the wheelchair 2 with the stair-climbing device 1 in the transport mode is more stable due to the fact that the drive units 76, 76a, 76b are situated close to the ground on which the wheelchair 2 moves, and as a result the centre of gravity of the assembly of the wheelchair 2 and the stair-climbing device 1 is lower. In one of the preferred embodiments the drive wheels 91 of the crawler units 89 are connected via the drive axle 45 that is generally parallel to the main axle 44, as shown in FIGS. 2 and 3. Such drive axle 45 additionally connects the crawler units 89, thus stiffening even more the structure of the stair-climbing device 1, in particular in the case of a stair-climbing device 1 with mobile crawler units 89, as described above. In a preferred embodiment of the stair-climbing device 1, the drive wheels 91 of the crawler units 89 are connected slidingly with the drive axle, and the crawler units 89 can slide along the drive axle 45, as described in more detail below. In another preferred embodiment the drive wheels 91 of the crawler units 89 are non-slidingly mounted on the drive axle 45. This means that the crawler units 89 are mounted on the drive axle 45 in a fixed position. In one of the embodiments of the stair-climbing device 1 the drive axle 45 has a fixed length, as shown in FIG. 2. In another embodiment of the stair-climbing device the drive axle 45 can be of a variable length, as shown. for example. in FIGS. 11 to 13. The drive axle length may be changed, for example, by retraction. Changing of the length of the drive axle 45 is effected in a similar way as of the main axle 44, as described in more detail below.

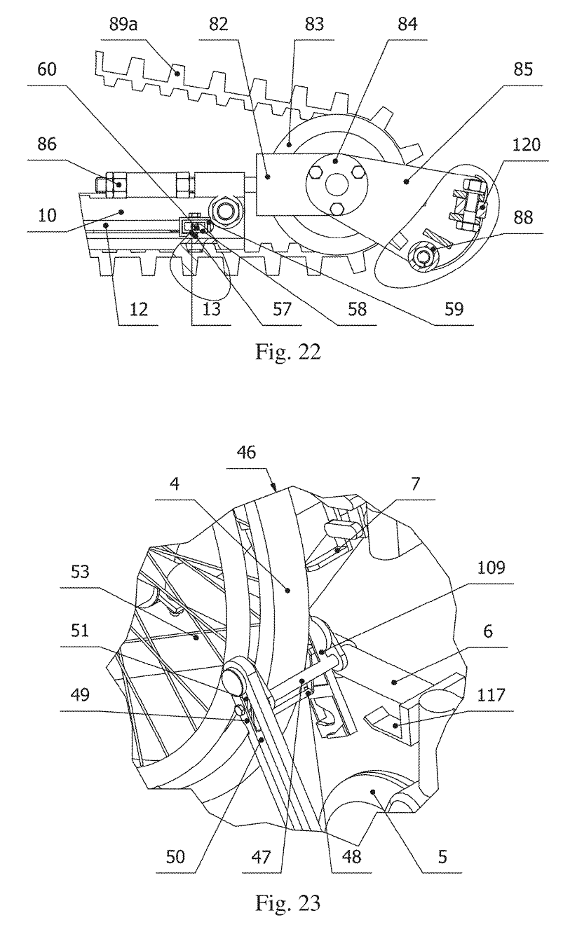

The front part of each frame 10, 15 is terminated by a front support 85, which is a holder for longitudinal auxiliary wheels 88 and for a lateral auxiliary wheels 120, as shown in FIG. 22. The longitudinal auxiliary wheels 88 comprise at least one wheel rotating in a direction parallel to the frame 10, 15 and they help to slide the frames 10, 15 and the crawler belts 89a in the transverse direction before and after stair-climbing mode, while the lateral auxiliary wheels 120 comprise at least one wheel that rotates in a direction perpendicular to the frame 10, 15 and help to shift the frames 10, 15 and the crawler belts 89a when they are being brought together for the transport mode for transporting the stair-climbing device 1.

Movement of the wheelchair 2 on stairs with the use of the climbing device 1 according to the invention is possible owing to the two crawler belts 89a, which can be put in motion by means of manual drive or an electric drive. Such a configuration makes the movement of the stair-climbing device 1 with the wheelchair 2 attached to it climb up stairs or down stairs, depending on the direction of rotation of the drive wheels 91, which drive the crawler belts 89a. Each of the crawler belts 89a is provided with teeth transverse to longitudinal direction of the crawler unit 89 which prevent the stair climbing device 1 from sliding down the stairs. There are also other components in the crawler belts 89a that correspond to these transverse teeth. For example, but without limitation, the crawler belts 98a, may have thread patterns, for example, such as block pattern, diagonal rib pattern, cross rib pattern, etc. to prevent sliding of the stair-climbing device 1 form stairs.

The wheelchair 2 is connected to the stair-climbing device 1 with a connecting unit which is able to change the crawler units 89 from the stair-climbing mode, wherein the crawler belts 89a rest on the ground and the main wheels 4 and the front wheels 5 of the wheelchair 2 are raised above the ground, to the transport position, wherein the main wheels 4 and the front wheels 5 of the wheelchair 2 rest on the ground while the crawler belts 89a are lifted above the ground, and vice versa.

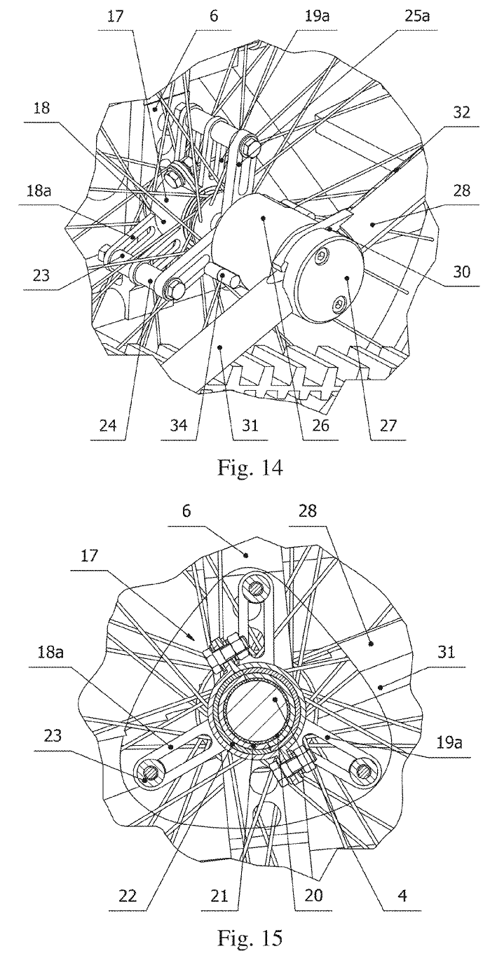

The connecting unit comprises two main arms 31, wherein each of them is connected to one end of the main axle 44 in such a way that they are able to rotate on the main axle. On the main arm 31 there is a sliding mount 26, that is adjusted to allow it to be attached from the external side of the main wheel 4, to the attachment device 17 mounted to the hub of the main wheel 4 of the wheelchair 2, for connecting the stair-climbing device 1 with the wheelchair 2 and for manual shifting the device 1 from the transport position to the stair-climbing position or the landing position, if the landing position is present, and vice versa. As shown in FIGS. 14 and 15, the attachment device 17 comprises the clamping parts 18, 19 around a wheel hub; the shape and the size of these parts are adjusted to the shape of the hub of the main wheels 4 of the wheelchair 2 and of the spokes mounted to this hub. In one of the preferred embodiments of the stair-climbing device 1 the crawler units 89 are located between the main arms 31 and the main wheels 4 of the wheelchair 2, as shown in FIG. 5. In another preferred embodiment of the stair-climbing device 1 the main arms 31 are located in a proximity to the main wheels 4 of the wheelchair 2 and the crawler units 89 are located opposite to the corresponding main wheels 4, preferably in a proximity to these main wheels 4 of the wheelchair 2 (not shown in Figures).

In the stair-climbing mode it is necessary that the stair-climbing device 1 holds the seat 3 of the wheelchair 2 in a nearly horizontal position. This is done by means of the levelling unit 105. In the stair-climbing mode the levelling unit 105 is connected to and interoperates with the supporting units 46 which support the main wheels 4 of the wheelchair 2, one for each main wheel 4. Each supporting unit 46 comprises a prop 47 which is located transversely and has a length greater than the width of the main wheels 4 of the wheelchair; its purpose is to support the main wheel 4 of the wheelchair 2 in a tilted position when the stair-climbing device 1 with the wheelchair 2 climbs stairs. The prop 47 is connected at one end with a front arm 49, coupled to the adjacent frame 10, 15 of the crawler unit 89 in such a way that it can slide along this arm 49. The prop 47 is connected at the other end with a rear arm 53. The rear arm 53 is connected with the main axle 44 in such a way that it can rotate around it.

The levelling units 105 of the stair-climbing device 1 are fixed to the frame 6 of the wheelchair 2, on both its sides, by means of the fastening components 106. Each levelling unit 105 comprises of an outer arm 107 and an inner arm 108 embedded in it telescopically to be able to slide in and out. By moving the inner arm 108 relatively to the outer arm 107, or vice versa, they lengthen or shorten, thus ensuring horizontal position of the seat 3 of the wheelchair 2 during stair climbing. The steeper set of stairs is the more extended the two arms 107 and 108 should be. After determination of the set tilt angle of the wheelchair 2 and appropriate setting and locking of the length of the arms 107, 108, the inner arm 108 is latched onto the prop 47 of the supporting unit 46, preventing uncontrolled tilting of the wheelchair 2 from the set position.

When the stair-climbing device 1 with the attached wheelchair 2 climbs the stairs, the stable position of the frames 10, 15 of the device 1 in relation to each other is generally ensured by the main axle 44 which connects the crawler units 89. The main axle 44 generally is located in any part of the stair-climbing device 1 according to the invention. In one of the preferred embodiments of the stair-climbing device 1, the main axle 44 is located essentially at the centre of the device 1. In another preferred embodiment of the stair-climbing device 1 the main axle 44 is located in the rear part of the device 1, as shown in FIG. 2. In one of the embodiments of the stair-climbing device 1 the main axle 44 has a fixed length, as shown in FIG. 2. In another embodiment of the stair-climbing device 1 the main axle 44 has a variable length which can be adjusted according to the needs. In such an embodiment of the stair-climbing device 1 the main axle 44 with variable length can be either in extended or retracted position. In the retracted position its minimum length can be, for example, suitable for the position of the crawler units 89 in their slid-together position, as for example in the transport mode. In turn, in its extended position it has a length suitable for the crawler units 89 in the their slid-apart position, as for example in the stair-climbing and/or landing mode. In one of the embodiments the main axle 44 with variable length comprises a telescopic joint 121, as shown, for example, in FIGS. 12 and 13. The telescopic main axle 44 comprises the first main semi-axle 44a and at least one second main semi-axle 44b; the second main semi-axle 44b can move inside the first main semi-axle 44a, thus enabling changing the length of the main axle 44. In a preferred embodiment of the stair-climbing device 1 the telescopic main axle 44 comprises one first semi-axle 44a and one second main semi-axle 44b, as shown in FIG. 12. In another preferred embodiment of the stair-climbing device 1 the telescopic main axle 44 comprises two telescopic joints 121. In one of the embodiments, as shown in FIG. 13, the telescopic main axle 44 comprises one first main semi-axle 44a which is situated in the central part of the main axle 44, and two second main semi-axles 44b which are situated on the outer sides of the first main semi-axle 44a and can move inside it towards the centre of the stair-climbing device 1 and back, thus changing the length of the main axle 44. In another embodiment the telescopic main axle 44 comprises one second main semi-axle 44a which is located in the central part of the main axle 44, and two first main semi-axles 44b which are located on the outer sides of the second main semi-axle 44a (not shown in the Figures). In such a case the central second main semi-axle 44b can move inside the corresponding external second main semi-axles 44b towards the centre of the stair-climbing device 1 and back, thus changing the length of the main axle 44. In yet another embodiment of the stair-climbing device 1 the main axle 44 constitutes the main swivel axle 44. In one of the embodiment examples the main swivel axle 44 comprises a central articulated joint 122a and two side articulated joints 122b, as shown in FIG. 11. The main swivel axle can bend in the articulated joints 122a and 122b in such a way that the parts of the main axle 44 between the joints 122a and 122b can either approach or move away from each other, thus causing change of the length of the main axle 44, depending on the needs.

In a preferred embodiment of the stair-climbing device 1 additional stabilization of the frame 10, 15 position of the crawler units 89 is ensured. In this preferred embodiment the additional stabilisation of the frame 10, 15 position of the crawler units 89 of the stair-climbing device 1 is ensured by the use of a lateral stabilising strut 56, which is located at a distance from the main axle 44. In an even more preferred embodiment the lateral stabilising strut 56 is located in the front part of the stair-climbing device 1, as shown in FIG. 2. The stabilising strut 56 is fixed at its one end to the front end of the frame 15 of one crawler unit 89. The other end of the stabilising strut 56 is mounted slidingly in the guide 12, which has the form of a groove in the frame 10 of the second crawler unit 89; additionally the stabilising strut 56 is connected with the frame 15 by articulated joints 16. The stabilising strut 56 in its extended position, in which the crawler units 89 are apart from each other, connects the front ends of the frames 10, 15 of the crawler units 89, while in its retracted position, in which the crawler units 89 are close to each other, it connects the front end of the frame 15 with the rear end of the frame 10. When the stair-climbing device 1 is being set to the stair-climbing mode, the other end of the stabilising strut 56 is moved in the guide 12 towards the front of the frame 10 until it reaches its target position, in which the full distance between the frames 10, 15 and the crawler belts 89a in relation to each other is reached. In the position of the intended full distance between the frames 10, 15 the stabilising strut 56 is immobilised, thus stabilising the position of the crawler units 89 in relation to each other. The above description concerns the stabilising strut 56 which is mounted in the front part of the stair-climbing device 1. Similarly, the stabilising strut 56 can be mounted in any part of the stair-climbing device 1, preferred in the rear part of the device 1. Based on the above disclosure a person of skill in the art will be aware of how to apply the above disclosure in order to install the stabilising strut 56 at any place of the stair-climbing device 1 according to the invention.

The stabilising strut 56 is used preferred in such embodiments of the stair-climbing device 1 where the crawler units 89 are moved from the slid-together to the slid-apart position, as described herein. For the embodiment with the fixed-position crawler units 89 as described above, at least one fixed stabilising component is used advantageously. This stabilising component additionally stiffens the structure of the stair-climbing device 1, and this at least one stabilising component is used at similar places, as described above for the stabilising strut 56.

For manual operation of the stair-climbing device 1 on stairs, as shown in FIG. 41, a manual drive unit is provided. The manual drive unit comprises a ratchet device 102 that is connected with the drive wheels 91 of the crawler belts 89a and the drive arms 35 that are separably connectable with the ratchet device 102. In one of the preferred embodiments of the stair-climbing device 1 the drive arms 35, when not in operation, are placed inside tubular main arms 31, as shown in FIG. 16. If it is needed to use the manual drive, they are connected with the ratchet device 102 and are used to manually rotate this ratchet device 102 and the drive wheels 91 of the crawler belts 89a in one direction. Alternatively, the ratchet device 102 can be located on the drive arm 35 and in such a case, it will be not required on the drive wheel 91.

For manual drive, as shown in FIG. 41, the occupant of the wheelchair 2 mounts the drive arm 35 by connecting it with the ratchet device 102 of each drive wheel 91 and, by moving the opposite end of the drive arm 35 on the principle of a lever, puts the drive wheel 91 into rotary motion, which is transferred into the forward motion of the crawler belts 89a in the specific direction. Each of the drive arms 35 is equipped with a push-button 38, located on its handle, which activates the safety brake 96. Use of the ratchet device 102 enables an occupant of the wheelchair 2 to move on stairs safely and conveniently. Use of the ratchet device 102 prevents uncontrolled movements of the drive arms 35 in undesired direction. Moreover, provision of the safety brake 96 makes it possible to protect the occupant of the wheelchairs 2 from uncontrolled movement of the wheelchair 2 when using the manual drive.

For the electric drive of the stair-climbing device 1 an electric drive assembly is provided, comprising the drive units 76, 76a, 76b, at least one electric motor 79 powered from the power supply unit 118 with a rechargeable battery. In a preferred embodiment of the stair-climbing device 1 the drive units 76, 76a, 76b are controlled by means of the control unit 119. In one of the preferred embodiments of the stair-climbing device 1, comprising the drive axle 45, as described above, the motor 79 of the drive unit 76 can be connected with this drive axle 45 by a mechanical transmission gear, as shown in FIGS. 2, 3 and 6. In this case both crawler units 89 are driven together by means of a common drive axle 45 by one drive unit 76. In another preferred embodiment the electrical drive comprises two drive units 76a, 76b, which are located in the corresponding drive wheels 91, as shown, for example, in FIG. 4, where the drive wheels 91 are located at the front of the crawler units 89. In this case both crawler units 89 are driven individually by one of the corresponding drive units 76a or 76b. Such an embodiment is particularly advantageous, because owing to the independent control of the drive units it is possible to enable turning of the wheelchair 2 when it is moving on the crawler units 89. For this reason the landing mode can be eliminated from the stair-climbing device 1. In addition, such an embodiment makes it possible to change the direction of movement of the wheelchair 2 on stairs, enabling movement of an occupant of the wheelchair 2 on curved flights of stairs, not even mentioning the possibility of correction of the wheelchair 2 occupant movement on a straight flight of stairs.

The manual drive and the electric drive can be used in the stair-climbing device 1 according to the invention either alternatively or together. In one of the embodiments of the stair-climbing device 1 the drive assembly contains only a manual drive, as described above. In this case the occupant of the wheelchair 2 moves by means of the stair-climbing device 1 exclusively by using the muscular force of his/her hands. Such an embodiment makes the user of the wheelchair 2 independent from access to energy sources. In another embodiment of the stair-climbing device 1 the drive assembly contains only an electrical drive, as described above. In this case the occupant of the wheelchair 2 moves by means of the stair-climbing device 1 which is electrically driven only. Such an embodiment is convenient for the user of the wheelchair 2. In yet another embodiment of the stair-climbing device 1 the drive assembly comprises both the manual drive and the electric drive, as described above. Switching from the electric drive mode to the manual drive mode is possible after decoupling the drive unit 76, 76a, 76b from the drive axle 45 or from the drive wheels 91 of the crawler units 89, respectively. Such an embodiment of the stair-climbing device 1 according to the invention combines the advantages of the manual drive and the electric drive described above. Moreover, in the event of a failure of one of the drives, an occupant of the wheelchair 2 can switch to the other drive and continue moving on the wheelchair 2 on the crawler units 89 of the stair-climbing device 1.

When the wheelchair 2 moves on level ground, the stair-climbing device 1 is in the transport mode, that means it is located behind the back-rest 8 of the wheelchair 2, above ground level and above the lowest point of the main wheels 4 of the wheelchair 2, as shown in FIGS. 6 and 8 to 10. In order to secure the stair-climbing device 1 in the transport position the wheelchair 2 is equipped with a hanger 116, which enables hanging the crawler units 89 of the device 1 in the vertical position. The hanger 116 is fixed to the handle 9 of the wheelchair 2 and allows the user to lift the crawler units 89 to the transport position and to attach them to the hanger 116 while being seated in the wheelchair. The hanger 116 can have any design, but it cannot create any limitations during normal use of the wheelchair when it moves on level ground.

The further part describes in more detail the individual units of the stair-climbing device 1, their positioning in relation to each other and their interaction in various modes of operation of the device 1 attached to the wheelchair 2.

FIG. 14 and FIG. 15 show in more detail the attachment unit 17 mounted on the hub of the main wheel 4 of the wheelchair 2 which is used to attach the connecting unit of the stair-climbing device 1. As shown in FIG. 1, the attachment unit 17 comprises the holder 25 and at least two parts 18, 19, which—when assembled together—clamp around the hub of each main wheel 4 of the wheelchair 2. A tight fitting of the parts 18, 19 to the hub of the main wheel 4 is ensured by a set of spacer half-rings 20, 21, 22, the number and the shape of which corresponds to the diameter and to the shape of the hub. The inner most ring 20, directly touching the hub, is made of a non-slip material, of rubber, due to which the attachment unit 17, after bolting together of the parts 18, 19, cannot rotate around the hub of the main wheel 4. From the parts 18, 19 the connectors 18a, 19a protrude, which are situated radially on the perimeter and comprise slotted holes through them. The holder 25, which is equipped with similarly shaped and accordingly arranged connectors 25a, is located on the external side of the main wheel 4 of the wheelchair 2. The bolts, connecting the parts 18, 19 with the holder 25, are put through the slotted holes of the connectors 18a, 19a and 25a. The large surface of the through-holes of the connectors 18a, 19a and 25a enables the positioning of the connecting bolts so that they do not interfere with the spokes of the main wheel 4 of the wheelchair 2. A constant and fixed distance as well as the fixed position of the parts 18, 19 in relation to the holder 25, are ensured by the stiffening sleeves 23 and the sleeve connector 24 with the connecting bolts passing through them. Such connection guarantees the fixed position of the attachment unit 17 in relation to the main wheel 4. The holder 25 of the attachment unit 17 is connected with the holder 26 mounted on the main arm 31 that is connected with the frames 10, 15 of the stair-climbing device 1 in such a way that it is possible for the holder 26 to rotate around the axle of the main wheel 4 of the wheelchair 2. This type of connection ensures a permanent connection of the stair-climbing device 1 with the wheelchair 2, while still allowing the main arm 31 to turn around the axle of the main wheel 4 of the wheelchair 2.

The holder 26 of the main arm 31 is equipped with a mechanism that allows it to be quickly disconnected from the holder 25 of the attachment unit 17, a so-called quick-connect fitting 34. The holder 26 is provided with an outside guard 27, fastened to it by bolts.

FIG. 16 shows in more detail the main arm 31, which on its external side is equipped with a ratchet 32, whose teeth have the oblique surface directed toward the free end of the main arm 31. In the holder 26 the movable interlock 28 is installed, pressed down by the spring 29 to the ratchet 32 of the main arm 31. The interlock 28 is shaped in such a way that, when it is pressed down tightly to the ratchet 32, it prevents sliding out of the main arm 31 in the backward direction in relation to the wheelchair 2 and at the same time it enables unobstructed sliding out of the main arm 31 in the opposite direction. In the guard 27 of the holder 26 a groove 30 is formed, which enables permanent locking of the interlock 28 in the position in which it is pulled off from the ratchet 32 of the main arm 31, without the need to keep the lever of the interlock 28 depressed.

The main arm 31 is provided with an extension limiter 33, which has the form of a flange and which is located in front of the holder 26; the limiter prevents the main arm 31 from sliding out completely beyond the holder 26. The drive arm 35 is located inside the main arm 31, that is formed of a hollow section, where such main arm 31 comprises a release button 43, as shown in FIG. 8, preventing undesired sliding out of the drive arm 35 from the main arm 31. The release button 43 must be pressed in order to enable sliding out of the drive arm 35 from the main arm 31.

The holder 26 comprises an auxiliary mechanism with a little crank (not shown in the Figures) for movement of the main arm 31 in the holder 26 when the stair-climbing device 1 is being switched from the position in the transport mode to the position in the stair-climbing mode, and optionally in the landing mode, if the landing mode is present, and vice versa. The auxiliary mechanism interacts with the ratchet 32 on the main arm 31 for the movement of this arm 31, as indicated above. In another preferred embodiment a worm is provided on the main arm 31 for interaction with the auxiliary mechanism. In yet another preferred embodiment a second ratchet is provided on the main arm 31 for interaction with the auxiliary mechanism only. Any means for interaction with the auxiliary mechanism can be used on the main arm 31 to move this main arm 31 within the holder 26. The occupant of the wheelchair can rotate the crank thus moving the stair-climbing device 1 easily and conveniently between the positions in the transport mode, stair-climbing mode and optionally in landing mode, if the landing mode is present. In another preferred embodiment the auxiliary mechanism described above comprises the electric motor 79 to provide a drive for moving of the stair-climbing device 1, as described above for the auxiliary mechanism with the crank. In this case the wheelchair occupant puts the electric motor 79 into operation and moves the stair-climbing device 1 even more easily and conveniently between the positions in the transport mode, in the stair-climbing mode and optionally in the landing mode, if the landing mode is present.

In one of the embodiments of the stair-climbing device 1, in particular—in the embodiments with collapsible main axle 44, as described above, the main arms 31 are collapsible. The retraction/extension of the main arms 31 is possible owing to the articulated joints 123a and 123b on the main arm 31, as it is shown, for example, in FIG. 10. Provision of articulated joints on the main arms 31 enables their retraction/extension, when they are connected with the collapsible main axle 44. In this case, retraction/extension of the main axle 44 is accompanied by simultaneous retraction/extension of the main arms 31, as it will be explained in more detail below.

The drive arm 35, formed as a tube, contains a hydraulic system with the push-button 38 accessible from outside; pressing of this push-button results in deactivation of the safety brake 96. In the embodiment shown in FIG. 17 this is done by moving the pressing element 40 in the direction of the drive axle 45. The pressing element 40 has the rotation axle connected with the holder 37; when not pressed down by the hydraulic piston 36 it retracts into the arm 35, enabling insertion of the drive arm 35 into the main arm 31, when it is not in use. After activation of the hydraulic system the pressing element 40 moves into the seat on the mandrel 100 of the ratchet 103 of the ratchet device 102, which results in pressing down of the lever 99 of the ratchet 98 of the safety brake 96. The drive arm 35 is attached to the ratchet device 102 that is permanently connected with the drive axle 45, in such a way that it is slid by the user onto the mandrel 100 of the ratchet 103, which enters into the profiled seat 39 on the mandrel 100 of the ratchet 103, which constitutes the end of the drive arm 35. The ratchet device 102 is provided with a switch 90 of the direction of rotation, used to switch the mode of operation of the ratchet device 102 between climbing up the stairs and climbing down the stairs.

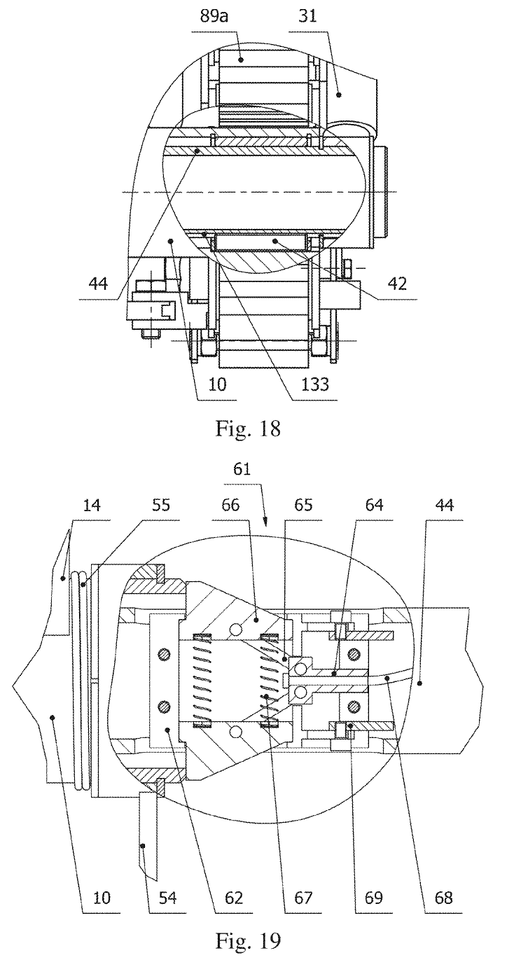

FIG. 18 shows more precisely the detail of the main axle 44 which connects both frames 10, 15 of the stair-climbing device 1, and also constitutes a support on which the main wheel 4 of the wheelchair 2 rests during operation in the stair-climbing mode. The main axle 44 comprises, on its entire length, a keyway 41 into which a key 42 is placed and which is also inserted in the frames 10, 15 of the crawler units 89. The pairing of the keyway 41 and the key 42 guarantees that the frames 10, 15 do not turn around the main axle 44 but slide in relation to it.

The locking mechanism 61 of the frames 10, 15, as shown in detail in FIG. 19, is to prevent undesired sliding of the frames 10, 15 of the crawler units 89 of the stair-climbing device 1 along the main axle 44; it also keeps the frames 10, 15 at a constant distance from each other during operation in the stair-climbing and the landing mode. The locking mechanism 61 comprises the lower casing 62 and the upper casing (not shown), between which locking wedges 66 are installed; the locking wedges prevent the frames 10, 15 from sliding towards the centre of the main axle 44. The entire locking mechanism 61 is fixed inside the main axle 44 by means of the retaining wedges 69. It is possible to slide the frames 10, 15 when the stabilising strut 56 is compressed into the transport position. During this action the wire cable 68, connected with the slider 64 of the locking mechanism 61, is tensioned by means of the holder 59 of the slider 58 of the stabilising strut 56, which causes movement of the slider 64 towards the centre of the main axle 44, i.e., to the right in FIG. 19, and causes movement of the guiding arms 65 to the centre of the main axle 44 and hiding of the wedges 66 connected with them inside the main axle. The wedges 66 return to the locking position automatically by being pushed by the springs 67, after release of the wire cable 68. Due to the profiled chamfer of the wedges 66, the wedges 66 are pushed inside of the main axle 44 when the frames 10, 15 move.

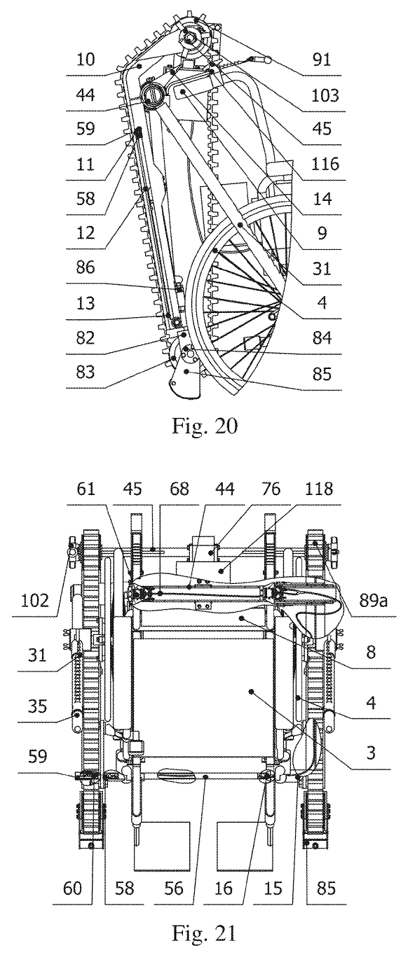

Operation of the stabilising strut 56 has been described with reference to FIGS. 20 to 22. FIG. 20 shows a side view of one frame 10, in this case it is the right frame as looking forward in direction of wheelchair 2 movement, in the transport position. The frame 10 differs from the other frame 15, left in the presented embodiment, in that it comprises the guide 12 of the stabilising strut 56 as well as the front 13 and rear 11 seats of the end positions in which the slider 58 of the strut is locked, respectively: in the completely wide open position and in the completely compressed position of the frames 10, 15 of the crawler units 89.

The stabilising strut 56 is fixed to the left frame 15 of the stair-climbing device 1 by the articulated joint 16, as shown in FIG. 21, which is the point of rotation of the stabilising strut 56 when the frames 10, 15 are being compressed or slid open. The opposite end of the stabilising strut 56 is terminated by the slider 58, which is embedded in the guide 12 in the right-hand frame 10 of the stair-climbing device 1. The slider 58 of the stabilising strut 56 is locked in the rear seat 11, as shown in FIG. 20, when the frames 10, 15 are compressed in the transport mode, or in the front seat 13, as shown in FIG. 22, when the frames 10, 15 are slid open in the stair-climbing mode of the stair-climbing device 1. The slider 58 of the stabilising strut 56 is locked in the end seats, i.e., in the rear seat 11 and in the front seat 13, by means of the mandrel 57, coupled with the holder 59 of the slider 58, as shown in FIG. 22. When the user pulls the holder 59 of the slider 58 in the direction perpendicular to the frame 10, the mandrel 57 protrudes and enables shifting of the slider 58 from its end position, thus displacing it to the opposite end position along the guide 12, which results in extension or retraction of the stabilising strut 56 connected to it. The mandrel 57 of the slider 58 automatically “jumps” into the grove of the rear seat 11 or the front seat 13 due to the pressing force of the spring 60.

Inside the stabilising strut 56 the cable wire 68 is installed—from the locking mechanism 61, that is located in the main axle 44, of the frames 10, 15 of the crawler units 89 along the frame 15 and the stabilising strut 56 up to its slider 58, through which the frame locking mechanism 61 can be released or activated by means of the holder 59.

As it is shown in particular in FIG. 20 and FIG. 22 each front wheel 83 is mounted on the axle 84, passing through the holder 82 which is fixed to the frame 10 or 15. The adjusting bolts 86 work with the holder 82; their purpose is to provide appropriate adjustment of the position of the holder 82 in relation to the frames 10, 15 and to obtain an adequate degree of tensioning of the crawler belts 89a. On the axle 84 also the front support 85 with frame is mounted, to which two auxiliary longitudinal wheels 88 and transverse wheels 120 are fixed. The axis of rotation of the longitudinal auxiliary wheel 88 is perpendicular to the frames 10, 15, which enables longitudinal movement of the device 1 on the ground during operation in the landing mode. The transverse auxiliary wheel 120 is mounted in the front support 85 is such a way as to enable its rotation transversely to the crawler units 89 when they are being brought together/slid apart in such a position when the frames 10, 15 with the crawler belts 89a are in a vertical position and are supported on the ground by the latter auxiliary wheels 120 of the front support 85, as shown in FIG. 12.

With regard to FIGS. 23 to 25, the supporting unit 46 that is shown in general view in FIGS. 2 and 5, as well as the levelling unit 105 that interacts with it, are discussed in more detail. The purpose of the supporting unit 46 is to support the main wheels 4 of the wheelchair 2 above the ground and in a tilted position during the stair-climbing mode.

The supporting unit 46 contains the prop 47, which supports the rear wheel 4 of the wheelchair 2 in a tilted position as well as the rear arm 53 and the front arm 49 attached to both ends of the prop 47. During lifting or lowering of the rear arm 53, the prop 47 moves in the groove 50, which is shaped in the front arm 49. On the front arm 49, in parallel to the prop 47, locking lever 51 is mounted, which can be unlocked by means of the latch 48 and which is pressed down to the locking position by the spring 52. Locking of the prop 47 by means of the locking lever 51 takes place at the moment when the prop 47 reaches its end position inside the groove 50 of the front arm 49. Unlocking of the prop 47 is effected by means of the latch 48, which also serves for disconnection of the prop 47 from the seat 104 of the inner arm 108 of the levelling unit 105, which interacts with the supporting unit 46, as will be explained hereinafter with reference to FIG. 25.

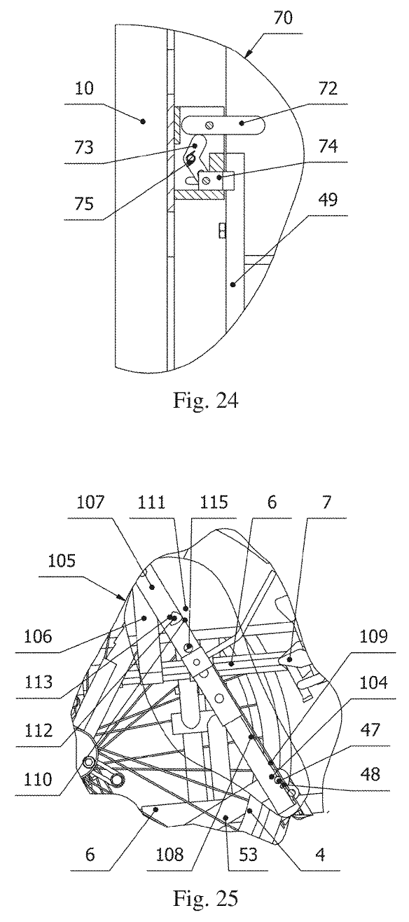

FIG. 24 shows an example of the locking mechanism 70 for the front arm 49 of the supporting unit 46. The locking mechanism 70 comprises the main lever 72 and the auxiliary lever 73 interacting with the former which is coupled with the wedge 74, used to block movement of the front arm 49.

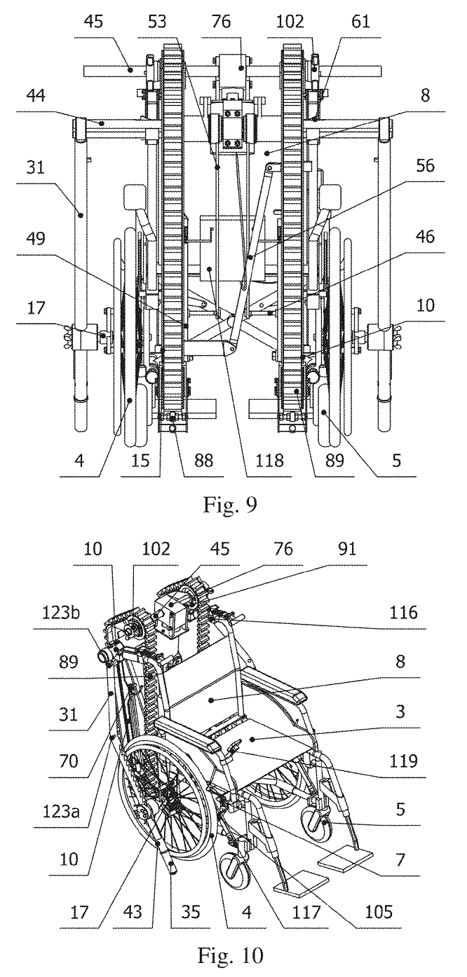

The levelling unit 105 is connected to the frame 6 of the wheelchair 2; it is shown in general view in FIGS. 5 and 7, and in more detail in FIG. 25. The levelling unit 105 comprises of the fastening element 106 which connects the levelling unit with the frame 6 of the wheelchair 2 and the outer arm 107 connected with it in such a way that it enables rotation of the outer arm 107 around the axis where it connects with the fastening element 106. The outer arm 107 contains inside it, the telescopically movable inner arm 108, which extends to a length, that is determined by the required tilt angle, which is set by means of the push button 112, that passes through the selected hole 115 on the length of the outer arm 107. On the outer arm 107 the slider 110 is located, with the lever 111 attached to it; the slider is connected with the inner arm 108. On the extendable end of the inner arm 108 the seat 104 is mounted, wherein the prop 47 of the supporting unit 46 is located. The prop 47 can be locked in the seat 104 by means of the locking element 109. The lever 111 of the slider 110 enables easy adjustment of the extension of the inner arm 108 in the following way: when the lever 111 is pressed by the user, the push button 112 is forced into the outer arm 107 by the interacting pressing element 113, thereby enabling shifting of the inner arm 108 in relation to the holes 115 of the outer arm 107. Movement of the slider 110 toward the seat 104 causes the locking element 109 to “run” into the seat 104, preventing the prop 47 from slipping out from the seat. Movement of the slider 110 in the opposite direction opens the seat 104, allowing the prop 47 to come out and, at the same time, causes that the latch 48 of the supporting unit 46 is pulled due to the specially profiled end of the locking element 109 of the slider 110, thus releasing the locking lever 51 and, by the same, allowing the arms 49, 53 to move downward. When the stair-climbing device 1 is not being used, the outer arm 107 and the inner arm 108 of the levelling unit 105 are attached to the landing device 117, located by the front wheels 5 of the wheelchair 2, as shown in FIGS. 4 and 9.

In order to start climbing up or down the stairs, the occupant of the wheelchair must position the wheelchair between the frames 10, 15 and roll in backwards. When the main wheels 4 of the wheelchair 2 pass the stabilising strut 56 and the props 47 that are located underneath, the main wheels 4 of the wheelchair 2 get caught by the main lever 72 of the locking mechanism 70 of the front arm 49 of the supporting unit 46, which causes a deflection of the auxiliary lever 73, which in turn draws off the key 74 toward the frame 10, 15, as shown in FIG. 24 and the frame 10 only has been shown in this Figure, thereby enabling rotary upward movement of the front arm 49 of the supporting unit 46. This movement is caused by the action of the tensioned spring 55 of the rear arm 53. As the rear arm 53 of the supporting unit 46 is coupled with the front arm 49 by means of the prop 47, simultaneous upward movement of both arms 49, 53 of the supporting unit 46 is possible.

Folding of the arms 49 and 53 of the supporting unit 46 to the horizontal position is possible after prior unlocking of the prop 47 and after it is disengaged from the seat 104 which is formed on the inner arm 108 of the levelling unit 105. Under the pressure of the main wheels 4 of the wheelchair 2, when it rolls forward from between the frames 10, 15 of the crawler units 89, the props 47 are gradually pressed down to the ground and when passing the wedges 74 cause them to move towards the frames 10, 15. After they have been passed, the wedges 74 return, due to the action of the springs 75, to a position which prevents the front arms 49 of the supporting unit 46 from lifting up.

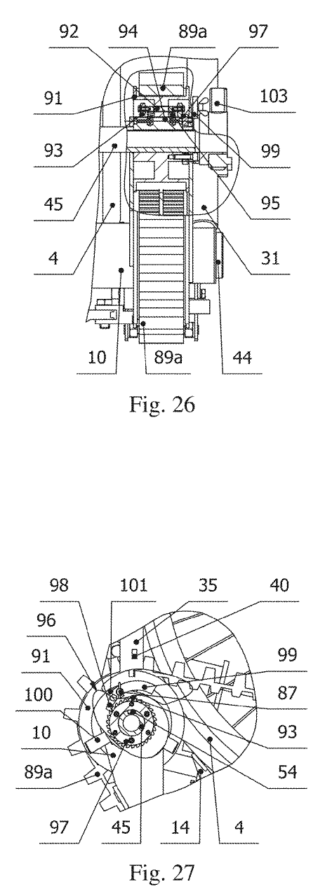

The stair climbing device 1 comprises a disconnecting mechanism to disengage the drive axle 45 from the drive wheel 91. This mechanism is required in situations when the user wants to use the device 1 in the manual mode while the drive unit 76 as mounted on the stair-climbing device 1 is not equipped with a mechanism for disconnection of the transmission gear 80 from the drive axle 45, which would make rotation of the drive axle 45 by hand impossible in such case. An exemplary embodiment of the disconnecting mechanism is shown in FIG. 26. Transition to the manual mode takes place once the drive wheel 91 is disconnected from the drive axle 45, which is effected when the key 94 slides out from the groove 54, machined in the drive axle 45. This is done by turning the two cams 93 around their axis 92 so that they are in a vertical upward position, which—owing to the cam springs 95—enables automatic raising of the key 94 above the groove of the drive axle 45. Re-connection of the drive axle 45 with the drive wheel 91 takes place by turning the cams 93 to a vertical downward position, in which the cams 93 will again start to press the key 94 into the groove of the drive axle 45. Other ways to disengage the drive axle from the drive wheel are also acceptable.

The stair-climbing device 1 is equipped with a safety brake 96, an example of which is shown in FIG. 27. The safety brake prevents undesired sliding of the stair-climbing device 1 with the wheelchair 2 down a flight of stairs during its operation in the manual mode. In this embodiment the safety brake 96 is connected to the drive wheel 91 and comprises a toothed ratchet-wheel 97, which is connected to the drive wheel 91 and to which the ratchet 98 is pressed down by the spring 101. The ratchet 98 blocks rotation of the toothed ratchet-wheel 97 and in turn rotation of the drive wheel 91 downwards in the direction of the stair-climbing device 1 down-climb. In the manual mode, in order to enable the stair-climbing device 1 to climb down stairs, it is necessary to pull the ratchet 98 from the toothed ratchet-wheel 97. This is made possible owing to hydraulic press-down element 40, which—after the push-button 38 is pressed, the hydraulic system on the drive arm 35 of the wheelchair—is pressed down to the lever 99 of the ratchet 98, which results in the ratchet 98 being pulled from the toothed ratchet-wheel 97 of the safety brake 96. As long as the push-button 38 of the hydraulic system remains depressed, then the ratchet 98 remains pulled from the toothed ratchet-wheel 97, allowing the stair-climbing device 1 to climb down stairs.

In case of climbing down stairs in the electric drive mode the safety brake 96 is locked by means of the locking bolt 87, which locks the lever 99 of the ratchet 98.

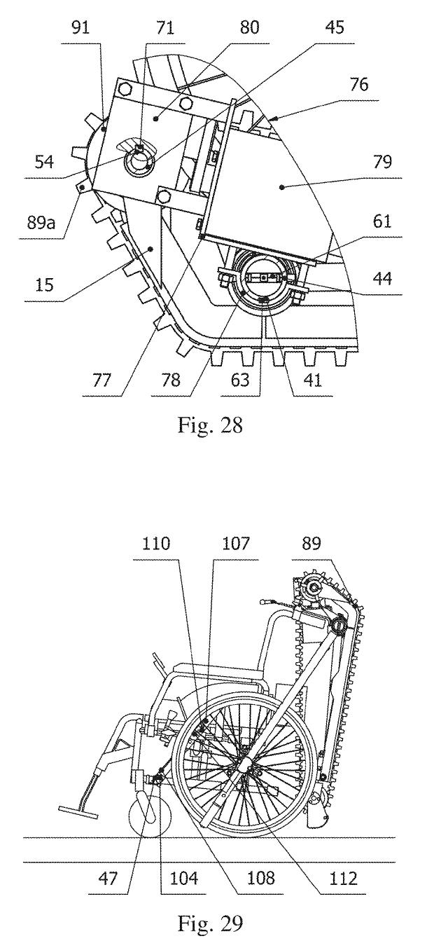

An example of the drive unit 76 for the stair-climbing device 1 operating in the electric mode is shown in more detail in FIG. 28. It comprises of at least one electric motor 79, mounted on the main axle 44, on the support 77, which is connected with the main axle 44 by means of the clamp 78 in such a way that the key 63 of the clamp enters into the groove 41, machined in the main axle 44; this prevents rotation of the support 77 around the main axle 44, but enables sliding movement of the clamp 78 along the main axle 44. The motor 79 or motors is/are coupled by means of at least one transmission gear 80 with the drive shaft of the electric motor 79 by means of a toothed belt. The rotary movement is transmitted on the drive axle 45 by the transmission gear 80, which is connected with the drive axle 45 through the keyway 54 and key 71 system. The exemplary drive unit 76 can be substituted by another one available in the market.

The control unit 119 of the stair-climbing device 1, as shown in FIGS. 5 and 6, is mounted on the frame 6 of the wheelchair 2 at a place convenient for the wheelchair user, for example on the arm-rests. Depending on the type of control unit 119, it can be connected to the drive unit 76 by cables, or wireless communication can be used. The drive unit 76 can be also controlled by means of mobile devices, such as smartphones or tablets, which do not have to be a part of the equipment of the stair-climbing device 1.

If the user has such mobile devices at their disposal, they can also connect wirelessly the selected mobile device to an optional camera, installed for example on the back-rest 8 of the wheelchair 2; this would enable the user to observe what is happening behind their back.

### Description how to Use the Stair-Climbing Device and the Wheelchair

The following sections describe, based on one embodiment of the stair-climbing device 1, as shown in FIG. 2, how to use the device in accordance to the invention in individual steps of the stair-climbing, landing and transport mode, as shown in FIG. 29-47, respectively.

### Stair-Climbing Mode

### Stair-Climbing Mode—Step 0: Prepare for Stair Climbing—FIG. 29

FIG. 29 shows the stair-climbing device 1 connected with the wheelchair 2, which moves on level ground and approaches the stairs. In this step the frames 10, 15 and the crawler units 89 of the stair-climbing device 1 are located behind the back-rest of the wheelchair 2.

After approaching the stairs the stair pitch should be measured in the case where it is not previously known. The stair pitch can be measured, for example, as follows:
A flat bar with angular scale and with a plumb line fixed in its centre is laid on the steps of the stairs perpendicularly to their flight. The plumb line deflects, due to gravity, by an angle equal to the stair pitch. The deflection from the vertical plane can be read on the angular scale.
By means of a level, operating on the same principle as the flat bar with a plumb line described above.
By means of a laser distance meter; this option is most convenient for persons who cannot stand up from a wheelchair on their own. By means of this instrument the distance parallel to ground level is measured. The second distance corresponds to the height at which the distance meter was positioned. When both distances are known, the stair pitch can be determined.

After determination of the stair pitch the range of the tilt of the wheelchair 2 should be determined. This range can be read from the tables supplied with the stair-climbing device 1; and for the user's convenience it is expressed by means of digits, symbols or colours.

Having determined the required tilt range of the wheelchair 2, the length of the arms 107, 108 of the levelling unit 105 should be adjusted; this is done by sliding the inner arm 108 into or out of the outer arm 107 until the desired position is obtained, which is marked accordingly for the selected stair pitch; then the selected position should be locked by means of the push button 112 in the appropriate hole 115 on the outer arm 107. The length of the arms 107, 108 of the levelling unit 105 can also be adjusted at later steps, but not later than in step 6. Moreover, the slider 110 of the levelling unit 105 should be set and locked in the open position, which makes it possible for the props 47 to enter into the seats 104 of the inner arm 108.

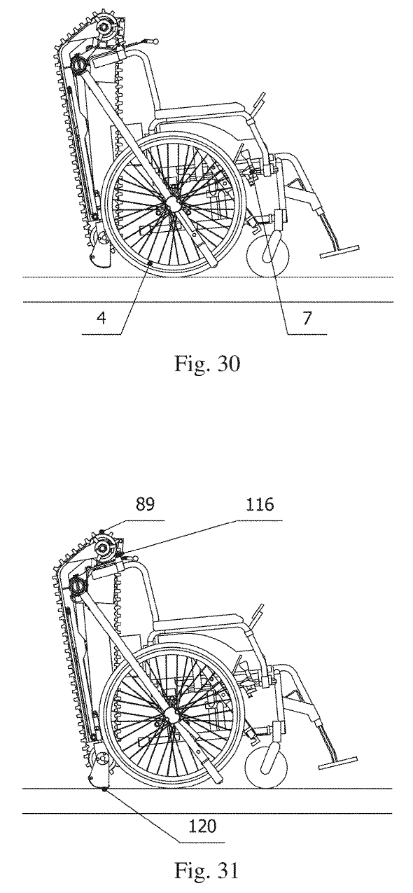

### Stair-Climbing Mode—Step 1: Approach the Stairs—FIG. 30

The wheelchair 2 occupant backs up to the stairs and sets the main wheels 4 of the wheelchair 2 at a distance of approx. 1.5 m from the stair riser of the first step. Both main wheels 4 should be placed at an equal distance from the stair riser, by which the axis of rotation of the main wheels 4 will be set in parallel to the first step of the stairs. After setting the wheelchair 2 in this position, the user pulls up both hand brakes 7 that the wheelchair 2 is equipped with.

Stair-Climbing Mode—Step 2: Take Off the Crawler Units from the Hanger—FIG. 31

The user releases the lever of the hangers 116 which lock the crawler units 89 and lowers the crawler units 89 until the lateral auxiliary wheels 120 rest on the ground. Lowering of the crawler units 89 is possible due to gravity. When the lateral auxiliary wheels 120 touch the ground, the hanger 116 is lowered a further 2-3 cm and left in this position until it is used again when the crawler units 89 are put on the wheelchair 2 once again in order to return to the transport mode.

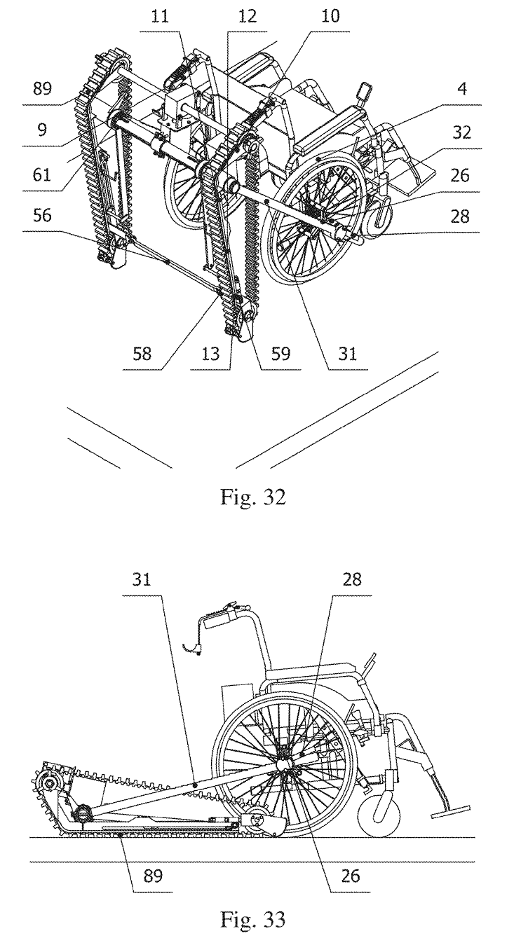

### Stair-Climbing Mode—Step 3: Slide the Crawler Units Apart—FIG. 32

The user shifts the main arms 31 backwards in their holders 26 so that both crawler units 89 are on the external side of the handles 9 of the wheelchair 2. Shifting of the main arms 31 backwards is made possible by pressing and shifting both levers of the interlock 28 of the main arms 31 into the groove 30. As a result of the above action the crawler units 89 move down until the moment when it is possible to move both of them apart from each other without them interfering with the handles 9 of the wheelchair 2. Alternatively, the main arms 31 can be shifted from the holders 26 by moving the wheelchair 2 forwards. Subsequently the user prevents any further backward movement of the main arms 31 by sliding both levers of the interlocks 28 of the main arms 31 from the groove 30 of the interlock, which causes the springs 29 again to begin to press down the interlocks 28 onto the ratchets 32 of the main arms 31.

The user, by pulling the holder 59 of the stabilising strut 56 outwards, causes it to unlock from the rear seat 11; then the user shifts the slider 58, holding its handle 59, of the stabilising strut 56 toward the front of the frame 10 inside the guide 12, until the front seat 13 is reached, in which it is immobilised, thereby preventing any movement of the stabilising strut 56. Shifting of the slider 58 of the stabilising strut 56 toward the front of the frame 10, i.e. downwards in the case where the crawler units 98 are in a vertical position, results in the crawler units 89 automatically moving apart from each other, they roll on the lateral auxiliary wheels 120 until they reach their target spacing in the stair-climbing mode, on the outside of the main wheels 4 of the wheelchair 2. As soon as the crawler units 89 reach their fully opened position, they are automatically locked in this position by means of the locking mechanism 61.

Stair-Climbing Mode—Step 4: Lower the Crawler Units onto the Ground—FIG. 33

By pressing the levers of the interlocks 28 of the main arms 31, the user shifts the main arms 31 from their holders 26 further backwards and lowers the crawler units 89 in an arch movement until both crawler units rest completely on the ground in a horizontal position.

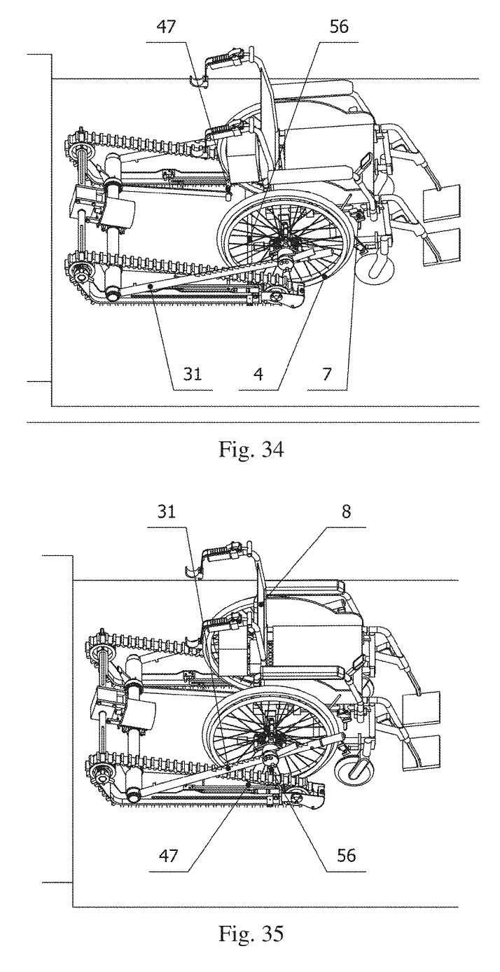

### Stair-Climbing Mode—Step 5: Set the Stair-Climbing Device for Stair Climbing—FIGS. 34 to 38

The user releases the hand brakes 7 of the wheelchair 2 and begins to roll back by manually turning the main wheels 4 of the wheelchair 2, until they encounter a resistance to the main wheels 4 caused by the stabilising strut 56 (FIG. 34).

The user continues to move the wheelchair 2 backward and passes over the stabilising strut 56 and the props 47. In the case where the wheelchair occupant does not possess enough strength to roll over the props 47, they can use the main arms 31 to assist them. In order to do this, the user holds with two hands both main arms 31 and—puts their back against the back-rest 8 of the wheelchair 2—they then pull the main arms 31 towards them. The result of this action is that the wheelchair starts moving backward and the main wheels 4 of the wheelchair roll over the props 47 (FIG. 35).

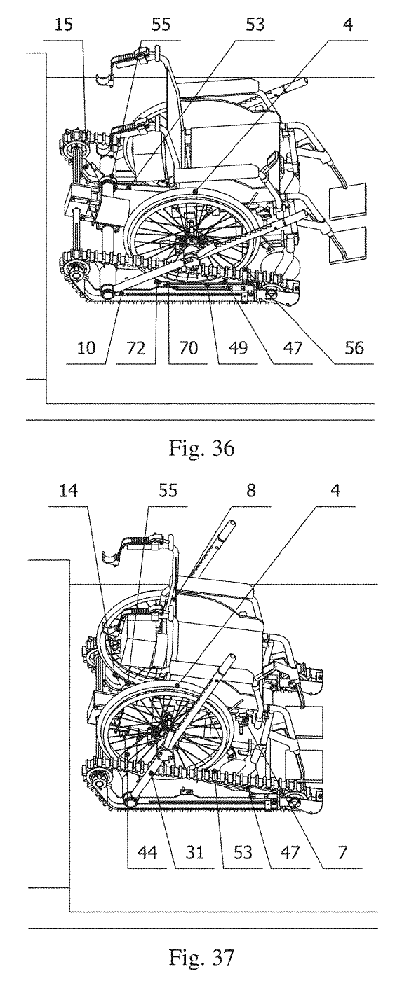

After passing over the stabilising strut 56 and the props 47, the user continues to move the wheelchair 2 backwards until its main wheels 4 of the wheelchair 2 press the main levers 72 of the locking mechanism 70 of the front arm 49 of the supporting unit 46, which releases the locking mechanisms 70 of the front arms 49 of the supporting unit. After release of the locking mechanisms 70 the front arms 49 of the supporting unit 46 are pushed upwards due to the action of the springs 55 of the rear arms 53 of the supporting unit 46. The front arms 49 constitute, at the same time, the guides for the props 47, which are permanently connected with the rear arms 53 of the supporting unit 46. The result of using such a system is that the rear arms 53 rise together with the front arms 49 (FIG. 36).

The user continues to move the wheelchair 2 backwards until the main wheels 4 encounter the resistance presented by the main axle 44. In the course of backward movement of the wheelchair 2 the props 47 are pushed higher and higher under the thrust of the springs 55 of rear arms 53 of the supporting units 46, until they are immobilised by the locking levers 51 in their target position. When the wheelchair 2 reaches the main axle 44, the user grasps the main arms 31 with both hands and turns the main arms 31 upwards leaning back against the back-rest 8 of the wheelchair 2. This movement causes the wheelchair 2 to start rotating around the main axle until the moment when the main wheels 44 touch the supports 14 of the rear wheels 4 of the wheelchair 2, which corresponds to the end position of the main arms 31. Alternatively, the user can drive the wheelchair onto the main axle 44 by turning the main wheels 4 of the wheelchair 2 by hand. At the end of this step the user applies the hand brakes 7 of the wheelchair 2 (FIG. 37).

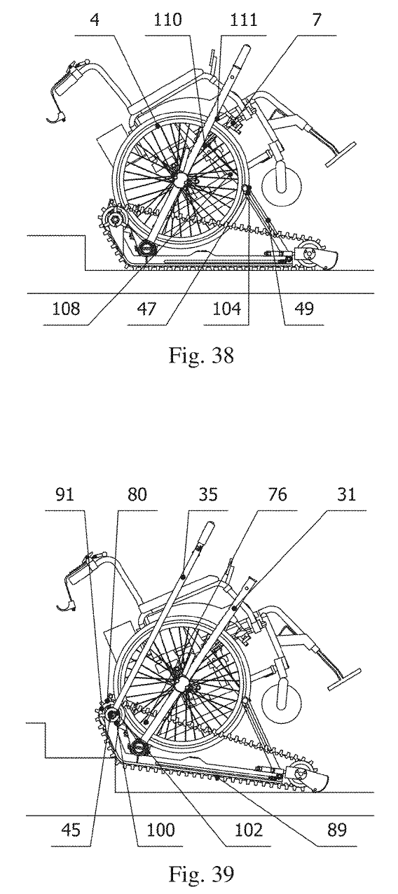

Before starting to turn the wheelchair 2 it is necessary to make sure that the sliders 110 of the levelling unit 105 are in the open position, which makes it possible for the props 47 to enter into the seats 104; subsequently the inner arms 108 should be put onto the props 47. The user starts turning the wheelchair 2 around the main wheels 4 by manually turning the main wheels 4, locked by the hand brake 7, until the moment when the props 47 are placed in the seats 104; this determines the end position of the rotary movement of the wheelchair 2 for its set tilt range. After the props 47 are placed in their seats 104, the user locks them by means of the lever 111 on the sliders 110, which at the same time immobilise the props 47, preventing their movement along the front arms 49 of the supporting unit 46 (FIG. 38).

Stair-Climbing Mode—Step 6: Start Climbing onto the Stairs—FIG. 39

Before starting to climb stairs in the manual mode the user must make sure that the drive unit 76 is disengaged, i.e. that the drive wheels 91 can rotate independently of the transmission gear 80 of the drive unit 76. For drives which are not provided by their manufacturer with the possibility of such disengagement from the drive axle 45 it is possible to do it by means of the manually operated unit described with reference to FIG. 26. In order to enable manual drive the wheelchair occupant pulls out the drive arms 35 from the inside of the main arms 31 and puts them onto one of the mandrels 100 of the ratchet device 102. For a more convenient grip the drive arms can be adjusted to have them bent at an angle of 90° in the direction of the wheelchair 2 axle after their connection with the ratchet device 102.

In the manual mode, the stair-climbing movement of the wheelchair 2 is effected by the manual pulling of the drive arms 35 by the wheelchair user to their chest. Return of the drive arms 35 to their initial position is effected by manually pushing them forward by the user; this action will not result in the return of the drive wheels 91 to their initial position due to the use of the ratchet device 102.

In the electric mode the progressive movement of the wheelchair 2 is possible owing to the electric motor 79 that is coupled with the drive axle 45 through the transmission gear 80. Climbing up onto the stairs begins by the rear part, i.e., the part tilted upwards, of the crawler units 89 driving onto the first step. The seat 3 of the wheelchair 2 is in the position tilted backwards until the first step has been climbed.

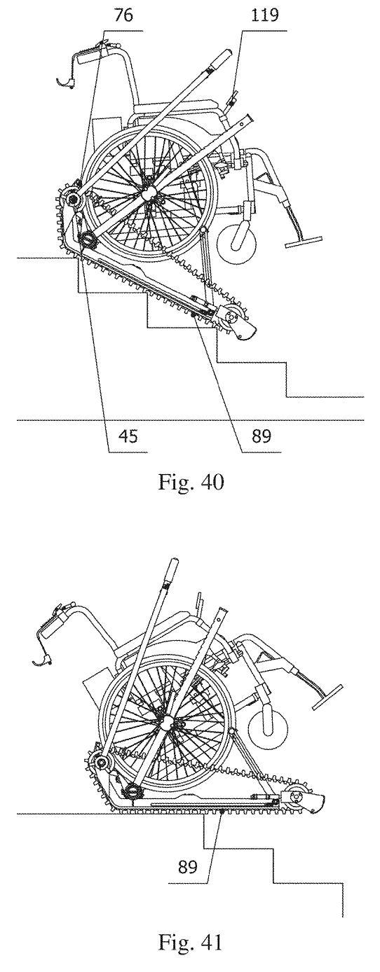

### Stair-Climbing Mode—Step 7: Stair Climbing—FIG. 40

After passing the first two steps by the wheelchair 2 the bottom of the crawler units 89 is fully supported by the stair steps, while the seat 3 of the wheelchair 2 is in a near horizontal position. Stair-climbing is effected by the use of the selected manual or electric drive until the end of the stairs is reached. In the electric drive mode the drive unit 76 is coupled with the drive axle 45, which means that the cams 93 press down on the decoupling keys 94 into the groove 54 of the drive axle 45 (FIG. 26). In the electric drive mode the stair-climbing unit is controlled by the control unit 119.

### Stair-Climbing Mode—Step 8: Change to Horizontal Movement—FIG. 41

Before transition of the stair-climbing device 1 with the wheelchair 2 back to horizontal travel, the user should slowly drive the wheelchair to a place where the tilted position is reached. Then, the person on the wheelchair should stop the wheelchair and, holding the stair handrail, should place the crawler units 89 of the stair-climbing device 1 on the stairway landing.

### Landing Mode

The next step is the transition to the landing mode. The landing mode enables wheelchair 2 movement on its own wheels, while maintaining the stair-climbing device 1 in a position of readiness for transition into the stair-climbing mode, if necessary. The landing mode begins from the moment when the stair-climbing device 1 goes into horizontal position after reaching the end of the stairs and comprises the following steps:

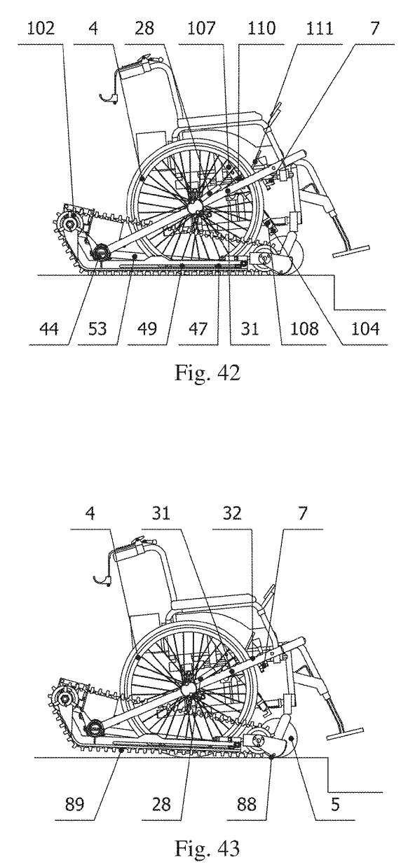

Landing Mode—Step 1: Roll Off from the Main Axle—FIG. 42

Return to rolling on level ground is possible after the stair-climbing device 1 has moved a distance, which will make it possible for the wheelchair 2 to drive away from the main axle 44. After driving away to a safe distance, the user—if they used the drive arms 35 for manual drive—disconnects them from the ratchet device 102 and slides them into the main arms 31 (in FIG. 42 they are shown in the retracted position). Then, while holding the lever 111 of the slider 110 of the levelling unit 105, slides up the sliders 110 upwards on the outer arms 107; this makes it possible to take off the inner arms 108 from the prop 47, as well as partial collapsing of the front arms 49 and the rear arms 53 of the supporting unit 46. After the props 47 go out from the seats 104 the tilt of the wheelchair 2 is levelled to the initial horizontal position. After unlocking the hand brakes 7, the user—by pressing the two levers of the interlocks 28 of the main arms 31 with two hands—drives the wheelchair 2 away from the main axle 44 to a distance which enables free movement of the wheelchair 2 on the main wheels 4.

### Landing Mode—Step 2: Lift the Crawler Units and Travel on Horizontal Surface—FIG. 43

Before starting to move on level ground horizontally it is necessary to lift the rear of the crawler units 89 slightly by approx. 4-6 cm above ground level. In order to do this the user locks the hand brakes 7 of the wheelchair 2 and, by turning down the main arms 31, lifts their rear part up, and in the same movement—the rear of the crawler units 89, until the desired height is reached. At this moment the user frees the main arms 31, which remain in an unchanged position thanks to the interlocks 28, pressed down by the springs 29 to the ratchet 32 of the main arms 31. In this position the fronts of the crawler units 89 begin to be lie on the longitudinal auxiliary wheels 88, and are ready for the landing mode.

In this setting, the user can move on the wheelchair 2 on its own wheels 4, 5, pulling the stair-climbing device 1 which is based only on the longitudinal auxiliary wheels 88.

If the user of the stair-climbing device 1 has to overcome another flight of stairs, transition to the stair-climbing mode is necessary; after setting the wheelchair into the stair-climbing mode in accordance with the guidelines applicable to step 1, the user goes through steps 5 through 8, inclusive.

### Transport Mode

If it is not necessary to climb consecutive flights of stairs, direct transition to the transport mode can take place, which involves the following steps:

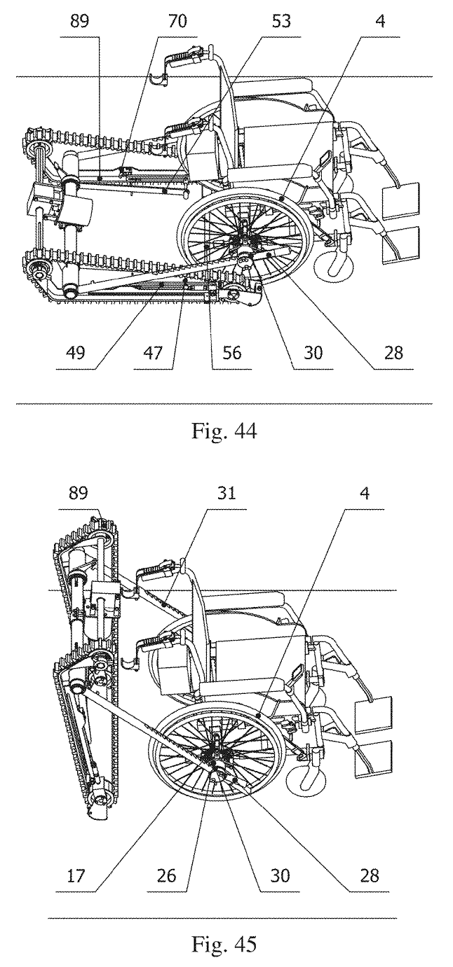

### Transport Mode—Step 1: Lock the Supporting Unit—FIG. 44

In the final step 2 of the landing mode the user drives out the wheelchair 2 from between the crawler units 89 until the main wheels 4 of the wheelchair 2 leave the stabilising strut 56. In order to do this the user presses down both levers of the interlocks 28 of the main arms 31 and then locks them in the pressed-down position by sliding them into the grooves 30 of the interlock (FIG. 14). The result of this action is that the rears of both crawler units 89 are again lowered onto the ground and the wheelchair 2 can freely move forward by rotation of the main wheels 4 of the wheelchair 2. Under the weight of the wheelchair 2 the props 47, and—as a consequence—also the front arms 49 and the rear arms 53 of the supporting unit 46 are pushed down to their extreme lower position, in which they are automatically locked by the locking mechanism 70 (FIG. 24). The wheelchair 2 stops immediately after leaving the stabilising strut 56.

### Transport Mode—Step 2: Lift the Crawler Units to the Vertical Position—FIG. 45

The user starts lifting both crawler units 89 into the vertical position. To this end the user unlocks both levers of the interlocks 28 of the main arms 31 by sliding them out of the grooves 30, which prevents uncontrolled backward sliding of the main arms 31 from the holders 26 connected with the attachment units 17 on the hub of the main wheels 4 of the wheelchair 2. Subsequently, the user turns the main arms 31 downward in relation to the axle of the main wheels 4 of the wheelchair 2, moving by this action the crawler units 89 upwards. Due to the weight of the crawler units 89, lifting of the whole units can be done in several times until the moment when the crawler units 89 begin to rest completely on the lateral auxiliary wheels 120 of the front support 85.

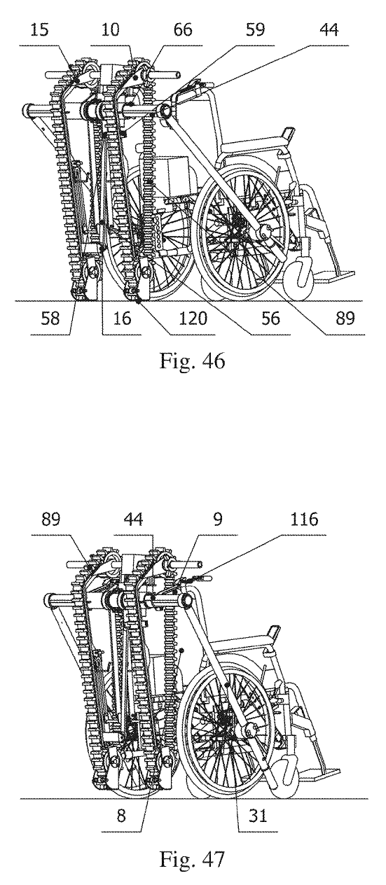

### Transport Mode—Step 3: Slide the Crawler Units Towards Each Other—FIG. 46

By pulling the handle 59 of the slider 58 of the stabilising strut 56, the user pulls out the mandrel 57 of the slider 58 from the front seat 13 of the guide 12 and slides the slider 58 backward up to the rear seat 11 of the guide 12, and slides the locking mandrel 57; this action locks the slider 58 and the stabilising strut 56 in its collapsed position (FIG. 22). The movement of the slider 58 to the rear of the frame 10 results in the stabilising strut 56 collapses in the articulated joint 16 between the second frame 15, and the frames 10, 15 automatically slide toward each other. When sliding towards each other the crawler units 89 are rolling on the lateral auxiliary wheels 120 of the front support 85 until the moment when the crawler units 89 reach their target spacing from each other, i.e. are in such a distance from each other that they are situated between the handles 9 of the wheelchair 2, which is shown in FIG. 46.

### Transport Mode—Step 4: Hang the Crawler Units on the Hanger of the Wheelchair—FIG. 47

As soon as the crawler units 89 are between the handles 9 of the wheelchair 2, the user turns the main arms 31 further downwards in relation to the axle of the main wheels 4 of the wheelchair 2, which causes pulling of the crawler units 89 toward the back-rest 8 of the wheelchair 2 until the main axle 44 touches the hanger belts 116 and rests on them. Subsequently, the user pulls the handles of the hangers 116 until the crawler units 89 are lifted above the ground by approximately 3-5 cm, i.e. when the handles 9 of the hanger 116 encounter resistance. After reaching the transport position, the crawler units 89 are secured against swinging on the hanger 116.

Moving the wheelchair 2 down the stairs by means of the stair-climbing device 1 requires the same actions as for climbing up the stairs in the stair-climbing mode, with the following conditions:
Before starting to descend the stairs with the use of the electric drive it is necessary to lock the locking bolts 87 of the lever 99 of the safety brake 96 ratchets (FIG. 27). In this mode the safety brake 96 is ensured by the self-braking feature of the drive unit 76.
For manual drive, the ratchet 103 of the ratchet device 102 should be set, by means of the switch 90, to the “down-climbing” position, and the user should at all times keep the push-buttons 38 of the hydraulic system, located on the handles of the drive arms pressed.

The idle position is obtained after complete disconnection of the stair-climbing device 1 from the wheelchair 2, which can be done by the user very quickly by pulling out the two main arms 31 from the holders 26 attached to the main wheel 4 hubs of the wheelchair 2. This pulling out can take place after prior unscrewing of the bolts 146 which connect the holder 26 of the main arm 31 with the guard 27 or even faster by disconnection of the quick-connect fitting 34 on the holder 26 of the main arm 31. The user should also disconnect the control and power supply cables from the electric motor 79. The idle position can be achieved with the frames 10 & 15 being in either the slid-together or the slid-apart position.

In this invention the main axle 44 is disclosed as the load-carrying element of the stair-climbing device 1, on which the crawler units 89 are mounted slidingly or non-slidingly; the main axle 44 may have a fixed length or may be collapsed, as described above. A person skilled in the art will be aware that any component can be used which enables to connect the crawler units 89 with each other and which will perform the functions, as described above for the main axle 44. For example, such a component may consist of a truss assembly for connecting the crawler units 89 with each other, preferably with pin-jointed elements for adjustment of the distance between these crawler units 89 in order to change their position in the transport mode, stair-climbing mode and landing mode, if the landing mode is present.

Based on the above disclosure a person skilled in the art will be aware that the longitudinal auxiliary wheels 88 and the lateral auxiliary wheels 120 can be replaced with such components that perform the function of these auxiliary wheels 88 and 120, as described above. For example, but without limitation, the frames 10, 15 of the crawler units 89 comprise sliders installed in place of the auxiliary wheels 88, 120 in such a way that some of these sliders help to move the frames 10, 15 in longitudinal direction, while other sliders help to move the frames 10, 15 when they are being slid-together.

The frames 10, 15 are the supporting element for mounting of the components of the crawler units 89, as described above. Based on the above disclosure a person skilled in the art will be aware that the frames 10, 15 of the crawler units 89 can be executed in a different way than the way described above. For example, but without limitation, the frames 10, 15 can be formed from an obtuse triangle section, where the components of the crawler units 89 are supported on the frames 10, 15, while the crawler belts 89a run around the frames 10, 15.

The drive arm 35 is disclosed above, as a hollow profile. However, the drive arm 35 can be executed in many ways in order to ensure a lever for manual drive and on which components of the stair-climbing device 1 are mounted, as described above. For example, but without limitation, the drive arm 35 can be made of a profile, such as a flat bar, T-profile, channel profile. A hollow profile may have any cross-section, for example, but without limitation: triangular, quadrangular, pentagonal, hexagonal, circular, oval, elliptical, etc.

In one of the embodiments of the stair-climbing device 1 the crawler units 89 are located on the external side of the main wheels 4 of the wheelchair 2, as shown in FIG. 5. In another embodiment of the stair-climbing device 1 the crawler units 89 are located on the inner side of the main wheels 4 of the wheelchair 2, as shown in FIG. 7. After having read the above disclosure a person skilled in the art will be aware of how to use the individual components in such a way so as to apply them in the stair-climbing device 1 with the crawler units 89 on the inner side or on the external side of the main wheels 4 of the wheelchair 2 respectively.

Based on the above disclosure a person skilled in the art will be aware that in case of the embodiment of the stair-climbing device 1 comprising an collapsible main axle 44, the moving of the crawler units 89 apart and bringing them back together, as described above in the steps of each mode, will also include the retraction or extension of the main axle 44 and of the main arms 31, and possibly the retraction or extension of the drive axle 45, if the stair-climbing device 1 comprises the drive axle 45 and if this drive axle 45 is collapsible.

The landing mode is optional. This means that it does not have to be available in the stair-climbing device 1 according to the invention. The landing mode is optional in particular in the embodiment of the stair-climbing device 1 according to the invention which comprises the drive assembly configured in such a way that the individual crawler units 89 are driven independently from each other, as described above, and enable changing the direction of movement of the wheelchair 2 on the crawler units 89 of the device 1. In such a case there is no need to switch the stair-climbing device 1 into the landing mode in order to approach the next flight of stairs, situated at a different direction in relation to the previous flight of stairs.

In case of an embodiment of the stair-climbing device 1 with a fixed position of the crawler units 89, as described above, a person skilled in the art will be aware that the operating modes of the stair-climbing device 1 described in detail hereinabove, and the manner of moving them apart and back together will not include, respectively, the sliding-apart and sliding-together of the crawler units 89 of the device 1.

The invention described above is widely used as a stair-climbing device which, when installed on any wheelchair, allows the wheelchair user to climb up and to climb down stairs without the assistance of a third party. The device can also be used by the wheelchair user to overcome, without the assistance of third parties, any kinds of steps and obstacles, for example high curbs, offsets etc., the overcoming of which otherwise would not be possible without the assistance of a third party and/or without leaving the wheelchair. The unique feature of the invention is the possibility to use either manual or electric drive. Thanks to manual drive mode, using the muscular force of the wheelchair occupant, this device can be used when or where access to electricity is limited or impossible.

In view of the above, the features indicated in the embodiments of the invention, as described hereinabove, and specifically in the preferred embodiments of the invention, can be combined with each other or replaced to any extent and in any combination, and all the possible new configurations or combinations thereof shall be deemed to be fully disclosed in the description of this invention.

The invention is described above using exemplary preferred embodiments. Based on the above disclosure a person skilled in the art will recognise that it is possible to make modifications, options or equivalents, falling within the inventive spirit and intent of this invention within the scope of the attached claims.

1-33. (canceled)

34. Stair-climbing device (1) for a wheelchair (2), comprising a frame (6), main wheels (4) comprising hubs, front wheels (5), a seat (3) and a back-rest (8), wherein the stair-climbing device (1) comprises:
two longitudinally arranged crawler units (89), which are connected with each other, preferably by a main axle (44);
connecting unit for connecting the stair-climbing device (1) with the wheelchair (2), comprising means for shifting the crawler units (89), when the stair-climbing device (1) is mounted on the wheelchair (2) from their position in stair-climbing mode, wherein the crawler units (89) rest on the ground and the wheels (4, 5) of the wheelchair (2) are raised above the ground, to the transport or optionally landing mode position, if the landing mode is present, wherein the crawler units (89) are raised above the ground and the wheels (4, 5) of the wheelchair (2) rest on the ground;
drive unit for driving the crawler units (89);
wherein the connecting unit comprises attachment devices (17) to be mounted on each hub of the main wheel (4) of the wheelchair (2) and holders (26) rotationally attachable to the corresponding attachment device (17), two main arms (31) mounted in the corresponding holders (26), preferably slidingly, and connected rotationally at one its end with the main axle (44) for changing the position of the stair-climbing device (1) in relation to the wheelchair (2) when the stair-climbing device (1) is mounted to the wheelchair (2) between said positions of the transport mode, stair-climbing mode and optionally landing mode, if said landing mode present.

35. Stair-climbing device according to claim 34, comprising further levelling unit (105) for setting the seat (3) of the wheelchair (2) in a horizontal position in the stair-climbing mode.

36. Stair-climbing device according to claim 34, wherein ends of the main arms (31) are further slidingly connected along the main axle (44).

37. Stair-climbing device according to claim 34, wherein, when the stair-climbing device (1) is mounted on the wheelchair (2), crawler units (89) are mounted in a proximity to the main wheels (4) of the wheelchair (2).

38. Stair-climbing device according to claim 37, wherein the crawler units (89) are located on the external side of the main wheels (4) of the wheelchair (2).

39. Stair-climbing device according to claim 37, wherein the crawler units (89) are located on the internal side of the main wheels (4) of the wheelchair (2).

40. Stair-climbing device according to claim 34, wherein the crawler units (89) are mounted slidingly on the main axle (44) and, when the stair-climbing device (1) is mounted on the wheelchair (2), they can slide along the main axle (44) between the slid-apart position, wherein the crawler units (89) are located apart from each other, and the slid-together position, wherein the crawler units (89) are located close to each other.

41. Stair-climbing device according to claim 40, comprising further a stabilising strut (56) for stabilising the position of the crawler units (89), wherein the stabilising strut (56) is connected hingedly at one its end to the front end of one crawler unit (89), and is mounted slidingly its other end in a guide (12) of the other crawler unit (89) so that in the slid-apart position of the crawler units (89) the stabilising strut (56) connects the front ends of these crawler units (89), and in the slid-together position of the crawler units (89) connects the front end of one crawler unit (89) with the rear end of the other crawler unit (89).

42. Stair-climbing device according to claim 34, wherein the crawler units (89) are fixedly mounted on the main axle (44) so that, when the stair-climbing device (1) is mounted on the wheelchair (2), they are in a fixed position on the main axle (44) irrespective of the operational mode.

43. Stair-climbing device according to claim 42, wherein the crawler units (89) are positioned on the main axle (44) for transport mode.

44. Stair-climbing device according to claim 34, wherein the main axle (44) and/or main arms (31) are collapsible.

45. Stair-climbing device according to claim 44, wherein the main axle (44) is a telescopic main axle and/or swivel main axle and the main arms (31) are telescopic main arms and/or swivel main arms.

46. Stair-climbing device according to claim 34, wherein the attachment device (17) comprises an adjustable connecting means for fastening it to the hub of the main wheel (4) and connecting means for connecting this attachment device (17) with the corresponding holder (26).

47. Stair-climbing device according to claim 34, wherein the holder (26) and the corresponding main arm (31) are equipped with the cooperating locking elements (28, 30, 32) for adjusting and locking the main arm (31) in the holder (26) in the set position on the length of the main arm (31).

48. Stair-climbing device according to claim 34, wherein the holder (26) is connected rotationally with the handle (25) of the attachment device (17) by means of the quick-connect fitting (34) and comprises the guard (27) attached to the external side of the holder (26).

49. Stair-climbing device according to claim 34, wherein the levelling unit (105) comprises an outer arms (107) for connecting with the frame (6) of the wheelchair (2) on each side of the said wheelchair (2) respectively by means of a fastening element (106) and an inner arms (108) telescopically slidingly installed inside the outer arm, wherein the levelling unit (105) is connected with a supporting unit (46) for supporting the main wheels (4) of the wheelchair (2) in a tilted position in the stair-climbing mode for preventing uncontrolled tilting of the wheelchair (2) from the set tilted position.

50. Stair-climbing device according to claim 49, wherein the supporting unit (46) comprises a front arm (49) coupled at one its end with the frame (10, 15) of the adjacent crawler unit (89), a rear arm (53) connected rotationally and slidingly at one its end with the main axle (44) and a prop (47) connecting the other ends of the front arm (49) and the rear arm (53) and is transverse to the frames (10, 15) and has a length corresponding to at least the width of the main wheels (4), the prop (47) for supporting the main wheels (4) of the wheelchair (2) in a tilted position when the stair-climbing device (1) with the wheelchair (2) moves on stairs.

51. Stair-climbing device according to claim 49 wherein the levelling unit (105) is connected with the supporting unit (46) by placing and locking of the prop (47) in a seat (104) shaped on a protruding end of the inner arm (108) of the levelling unit (105).

52. Stair-climbing device according to claim 34, wherein the crawler units (89) comprise the crawler belts (89a), and the drive assembly comprises the drive wheels (91) engaged with the crawler belts (89a) of the corresponding crawler units (89) so that they transmit rotation to the crawler belts (89a) of these crawler units (89).

53. Stair-climbing device according to claim 52, wherein the drive assembly comprises a drive axle (45) joined with the drive wheels (91) of the drive assembly.

54. Stair-climbing device according to claim 53, comprising further a disconnecting mechanism for disengaging the drive axle (45) from the drive wheels (91) of the drive assembly.

55. Stair-climbing device according to claim 52, wherein the drive wheels (91) are separably connected to a drive arms (35) for manual driving the crawler unit (89).

56. Stair-climbing device according to claim 55, wherein the drive arms (35), when not in use, are placed inside the corresponding drive arms (31).

57. Stair-climbing device according to claim 52, wherein the drive assembly comprises drive units (76a, 76b) located in the drive wheels (91) of the drive assembly for the independent driving the corresponding crawler units (89).

58. Stair-climbing device according to claim 53, wherein the drive assembly comprises a drive unit (76) located on the drive axle (44) for driving the drive assembly.

59. Stair-climbing device according to claim 57, wherein the drive unit (76) comprises an electric motor (79) connected to a power supply unit (118).

60. Stair-climbing device according to claim 59, wherein the drive unit (76) is connected to the power supply unit (118) is controlled by a control unit (119).

61. Stair-climbing device according to claim 52, wherein at least one of the crawler units (89) comprises further a manually operated ratchet device (102) engaged with the corresponding drive wheel (91) of the drive assembly for unidirectional driving the crawler unit (89).

62. Stair-climbing device according to claim 53, wherein the drive axle (45) is collapsible.

63. Stair-climbing device according to claim 62, wherein the drive axle (45) is a telescopic drive axle and/or a swivel drive axle.

64. Stair-climbing device according to claim 52, wherein the drive wheel (91) of the drive assembly is engaged with a safety brake (96) comprising means for locking the rotation of the drive wheel (91) during down-climbing movement of the stair-climbing device (1) in the stair-climbing mode.

65. Stair-climbing device according to claim 34, wherein the front part of the crawler unit (89) is terminated by a front support (85), on which an longitudinal auxiliary wheel (88) is mounted for assisting in longitudinal movement of the crawler unit (89) on the ground, and a lateral auxiliary wheel (120) for assisting in transverse sliding of the crawler unit (89) on the ground when the mode of operation of the stair-climbing device (1) is being changed.

66. Wheelchair (2) suitable for attaching a stair-climbing device (1) according to claim 34, wherein the wheelchair (2) comprises:
a fastening element (106) mounted on the frame (6) of the wheelchair (2) for connecting the levelling unit (105) to the wheelchair (2);
an attachment device (17) comprising at least two parts (18), (19) with the connectors (18a, 19a) radially located on the circumference, the connectors (18a, 19a) comprising elongated holes, wherein the parts (18, 19) embrace the hub of each main wheel (4) of the wheelchair (2) and are connected with a handle (25), and under which filling half-rings (20, 21, 22) are placed, wherein a number in the radial direction and shape of the filling half-rings (20, 21, 22) correspond to the diameter and the shape of the main wheel (4) hub of the wheelchair (2);
the hanger (116) mounted behind the back-rest (8) of the wheelchair (2) for hanging the crawler units (89) in the transport mode of the stair-climbing device (1).

67. Assembly of a stair-climbing device (1) and a wheelchair comprising a wheelchair according to claim 66 and a stair-climbing device (1) mounted thereon, the stair climbing device comprising a frame (6), main wheels (4) comprising hubs, front wheels (5), a seat (3) and a back-rest (8), wherein the stair-climbing device (1) comprises:
two longitudinally arranged crawler units (89), which are connected with each other, preferably by a main axle (44);
connecting unit for connecting the stair-climbing device (1) with the wheelchair (2), comprising means for shifting the crawler units (89), when the stair-climbing device (1) is mounted on the wheelchair (2) from their position in stair-climbing mode, wherein the crawler units (89) rest on the ground and the wheels (4, 5) of the wheelchair (2) are raised above the ground, to the transport or optionally landing mode position, if the landing mode is present, wherein the crawler units (89) are raised above the ground and the wheels (4, 5) of the wheelchair (2) rest on the ground;
drive unit for driving the crawler units (89);
wherein the connecting unit comprises attachment devices (17) to be mounted on each hub of the main wheel (4) of the wheelchair (2) and holders (26) rotationally attachable to the corresponding attachment device (17), two main arms (31) mounted in the corresponding holders (26), preferably slidingly, and connected rotationally at one its end with the main axle (44) for changing the position of the stair-climbing device (1) in relation to the wheelchair (2) when the stair-climbing device (1) is mounted to the wheelchair (2) between said positions of the transport mode, stair-climbing mode and optionally landing mode, if said landing mode present.
